(19) United States
(12) Patent Application Publication
(10) Pub. No.: US 2024/0176135 A1
(43) Pub. Date: May 30, 2024

(54) SYSTEMS AND METHODS FOR IMPROVED OPTICAL SYSTEMS

(71) Applicant: Meta Platforms Technologies, LLC, Menlo Park, CA (US)

(72) Inventors: Kiseung Bang, Bothell, WA (US); Murat A. Yokus, Kirkland, WA (US); Muhammed Talha Agcayazi, Bothell, WA (US); Ahmet Mesut Alpkilic, Seattle, WA (US); Sadhana Devulapalli, Foster City, CA (US); Bikash Mishra, San Mateo, CA (US); Suma Manoraj, Santa Clara, CA (US); Priyankha Bhalasubbramanian, Sunnyvale, CA (US); Vidya Srinivasan, Sunnyvale, CA (US); Benjamin Arthur Kevess Cohen, San Francisco, CA (US); Shyamal Jitendrakumar Shah, Wesley Chapel, FL (US); Ye Yin, Pleasanton, CA (US); Wei Huang, San Diego, CA (US); Yasuo Morimoto, Cupertino, CA (US); Boon Shiu, Palo Alto, CA (US); Jiang Zhu, Cupertino, CA (US)

(21) Appl. No.: 18/521,914

(22) Filed: Nov. 28, 2023

Related U.S. Application Data
(60) Provisional application No. 63/484,201, filed on Feb. 10, 2023.
(60) Provisional application No. 63/486,832, filed on Feb. 24, 2023.
(60) Provisional application No. 63/484,061, filed on Feb. 9, 2023.
(60) Provisional application No. 63/385,265, filed on Nov. 29, 2022.
(60) Provisional application No. 63/481,363, filed on Jan. 24, 2023.

(51) Int. Cl. G02B 27/00; G02B 27/01; G02B 27/09; G06F 3/01

(52) U.S. Cl. CPC G02B 27/0081; G02B 27/0093; G02B 27/0172; G02B 27/0944; G06F 3/015; G02B 2027/0123

(57) ABSTRACT

A display system may include a light source and a waveguide coupler configured to couple light from the light source. A waveguide coupler may include an in-coupling region and an out-coupling region having a plurality of multiplexed volumetric Bragg gratings. A computer-implemented method may include measuring from different angles, by at least one processor and using an imaging technique, skin hair coverage in a skin surface region of a user. Another computer-implemented method may include identifying and mitigating potentially harmful messages in public forums. A further computer-implemented method may include receiving, by at least one processor, imaging results from at least one imaging device. A system may include a substrate and a transparent conductive material applied to the substrate in a specified pattern that forms an antenna. Various other devices, systems, and methods are also disclosed.

### CROSS-REFERENCE TO RELATED APPLICATIONS

This application claims the benefit of priority under 35 U.S.C. § 119(e) of U.S. Provisional Application No. 63/484,201 filed Mar. 2, 2023, Provisional Application No. 63/486,832 filed Feb. 24, 2023, Provisional Application No. 63/484,061 filed Feb. 9, 2023, Provisional Application No. 63/385,265 filed Nov. 29, 2022, and Provisional Application No. 63/481,363 filed Jan. 1, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a diagram illustrating a 1D exit pupil expansion (EPE) waveguide structure, in accordance with various embodiments.

FIG. 2A shows a graph illustrating a coupling relation of a conventional diffractive grating when n₁=1.5, in accordance with various embodiments.

FIG. 2B shows a graph illustrating a coupling relation of a conventional diffractive grating when n₁=2.0, in accordance with various embodiments.

FIG. 3 shows a graph illustrating an ideal coupling relation, in accordance with various embodiments.

FIG. 4 is a graph illustrating a coupling relation of a properly designed volume Bragg grating (VBG) zipping coupler, in accordance with various embodiments.

FIG. 5A is a graph illustrating a coupling relation of a single VBG in an angle-spectrum domain, in accordance with various embodiments.

FIG. 5B is a graph illustrating a spectral selectivity curve along a linear cross-section of the graph of FIG. 5A, in accordance with various embodiments.

FIG. 6 is a graph illustrating an angle-spectrum coupling relation of a properly designed zipping VBG coupler, in accordance with various embodiments.

FIG. 7 is a chart illustrating a specification of a properly designed zipping VBG coupler, in accordance with various embodiments.

FIG. 8 is a diagram illustrating Bragg matching wavelengths in 2D out-coupled angle space, in accordance with various embodiments.

FIG. 9 is a diagram illustrating Bragg matching bands in 2D guiding angle space, in accordance with various embodiments.

FIG. 10A is a diagram illustrating signal intensity, in accordance with various embodiments.

FIG. 10B is a diagram illustrating noise intensity, in accordance with various embodiments.

FIG. 10C is a diagram illustrating combined signal and noise intensity, in accordance with various embodiments.

FIG. 11A is a diagram illustrating a 2D EPE waveguide using a mixed waveguide and its k-space diagram, in accordance with various embodiments.

FIG. 11B is a diagram illustrating Bragg matching wavelength in 2D out-coupled angle space for the 2D EPE waveguide of FIG. 11A, in accordance with various embodiments.

FIG. 12 is an illustration of exemplary augmented-reality glasses that may be used in connection with embodiments of this disclosure.

FIG. 13 is an illustration of an exemplary virtual-reality headset that may be used in connection with embodiments of this disclosure.

FIG. 14 is a flow diagram of an exemplary method for human-computer interaction.

FIG. 15 is a block diagram of an exemplary system for human-computer interaction.

FIG. 16 is a block diagram illustrating an exemplary network implementation of a system for human-computer interaction.

FIG. 17 is a perspective view of exemplary dome-shaped microelectrodes for human-computer interaction.

FIG. 18 is a perspective view of exemplary conical-shaped microelectrodes for human-computer interaction.

FIG. 19 is a graphical illustration of exemplary effects of heights on impedance at 1.2 mm pitch for microstructures of electrodes for human-computer interaction.

FIG. 20 is a graphical illustration of exemplary effects of heights on impedance at 2.4 mm pitch for microstructures of electrodes for human-computer interaction.

FIG. 21 is a graphical illustration of exemplary effects of absence of hair on impedance of microstructures on surfaces of electrodes for human-computer interaction.

FIG. 22 is a graphical illustration of exemplary effects of presence of hair on impedance of microstructures on surfaces of electrodes for human-computer interaction.

FIG. 23 is a set of perspective views of exemplary hair coverage of a subject in a skin region for application of microelectrodes for human-computer interaction.

FIG. 24 is a set of perspective views of exemplary hair coverage of another subject in a skin region for application of microelectrodes for human-computer interaction.

FIG. 25 is a graphical illustration of exemplary effects of hair density of subjects on impedance at 1.2 mm pitch for microelectrodes for human-computer interaction.

FIG. 26 is a graphical illustration of exemplary effects of hair density of subjects on impedance at 1.2 mm pitch for microelectrodes for human-computer interaction.

FIG. 27 is an illustration of exemplary haptic devices that may be used in connection with embodiments of this disclosure.

FIG. 28 is an illustration of an exemplary virtual-reality environment according to embodiments of this disclosure.

FIG. 29 is an illustration of an exemplary augmented-reality environment according to embodiments of this disclosure.

FIG. 30A is a prospective illustration of an exemplary human-machine interface configured to be worn around a user's lower arm or wrist

FIG. 30B is an illustration of an exemplary human-machine interface configured to be worn around a user's lower arm or wrist.

FIG. 31A is a prospective illustration of an exemplary schematic diagram with internal components of a wearable system.

FIG. 31B is an illustration of an exemplary schematic diagram with internal components of a wearable system.

FIG. 32 illustrates an overview of the systems and methods disclosed herein.

FIG. 33 is a flow diagram of an exemplary method of tensor-based cluster matching for optics system color matching.

FIG. 34 is a block diagram illustrating an example of image calibration.

FIG. 35 is graphical illustration of an example color correction matrix.

FIG. 36 is a graphical illustration of an example color correction matrix with interaction items.

FIG. 37 is a graphical illustration of sensor exposure time versus stimulus illumination intensity.

FIG. 38 is a graphical illustration of a vignette effect of an overall imaging system.

FIG. 39 is a graphical illustration of procedures relating to color correction matrix estimation.

FIG. 40 is a graphical illustration of a first iteration of a procedure performing iterative tuning of exposure time and conjugate of a vignette factor.

FIG. 41 is a graphical illustration of a twentieth iteration of the procedure performing iterative tuning of exposure time and conjugate of a vignette factor.

FIG. 42 is a graphical illustration of a spectrometer reference patch showing a result of all color patches.

FIG. 43 is a graphical illustration of a processed patch with fixed exposure time and vignette factor.

FIG. 44 is a graphical illustration of processed optimizations with exposure time and vignette factor.

FIG. 45 is a graphical illustration of a transparent uniplanar right hand circular polarized (RHCP) antenna with a relatively simple feeding mechanism.

FIG. 46 is a graphical illustration of a transparent, uniplanar, right hand circularly polarized (RHCP) antenna constructed from transparent metal mesh.

FIG. 47 is a graphical illustration of a simulated return loss and axial ration for a transparent right hand circularly polarized antenna.

FIG. 48 is a graphical illustration of a second simulated return loss and axial ration for a transparent right hand circularly polarized antenna.

FIG. 49A is a graphical illustration of a first simulated surface current at a frequency of 1575 MHz.

FIG. 49B is a graphical illustration of a second simulated surface current at a frequency of 1575 MHz.

FIG. 49C is a graphical illustration of a third simulated surface current at a frequency of 1575 MHz.

FIG. 49D is a graphical illustration of a fourth simulated surface current at a frequency of 1575 MHz.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Display technologies for artificial reality (e.g., augmented reality) displays may utilize diffractive waveguide couplers to project images to a user's eyes. However, such display systems may suffer from limited field of view (FOV) caused by limited available guiding angles inside of conventional waveguide mediums. Using a higher-index medium is a common approach to increase FOV. However, the use of such higher-index mediums can be very expensive and may still result in a limited FOV, with only marginal increases in FOV being realized in many cases.

The present disclosure is generally directed to display systems, devices, and methods that include volume Bragg grating (VBG) coupling waveguides. According to at least one embodiment, a wide FOV can be achieved by using an optimized VBG coupler. The disclosed VBG couplers may provide wide FOVs using conventional low-index materials for the waveguides. According to at least one example, an optimized VBG coupler may enable delivery of a wide FOV using a relatively narrower guiding angle range. Such a wide FOV may be realized because the VBG has high spectral selectivity. Accordingly, multiple angles in FOV can be delivered at a single guiding angle, as long as their wavelength is different from each other. In one example, an FOV of approximately 120°×120° may be achieved with 1.5-refractive-index waveguides. Accordingly, the systems presented in this disclosure may provide low-cost, wide-FOV waveguides. Optimized light sources may be used together for maximum efficiency, providing angle (or pixel)-dependent wavelength control.

Features from any of the embodiments described herein may be used in combination with one another in accordance with the general principles described herein. These and other embodiments, features, and advantages will be more fully understood upon reading the following detailed description in conjunction with the accompanying drawings and claims.

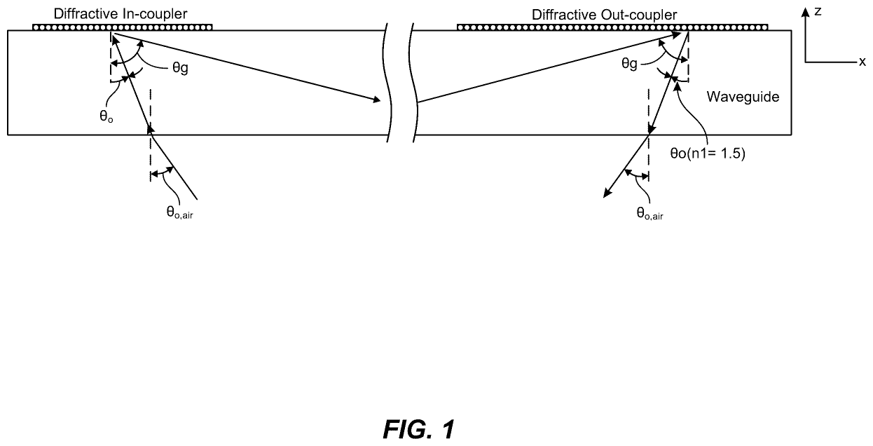

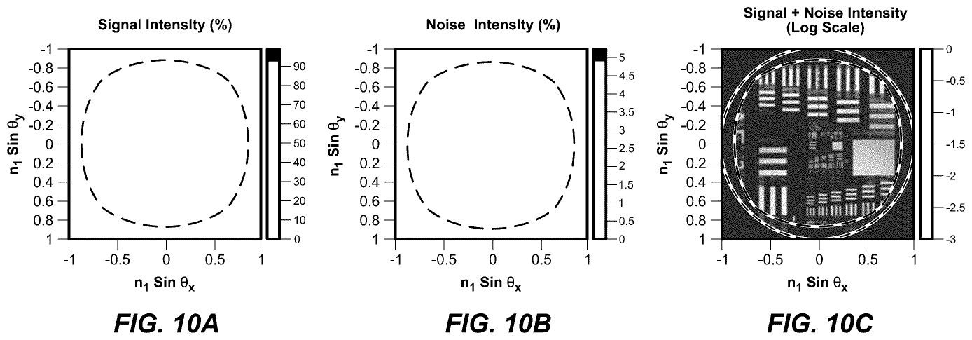

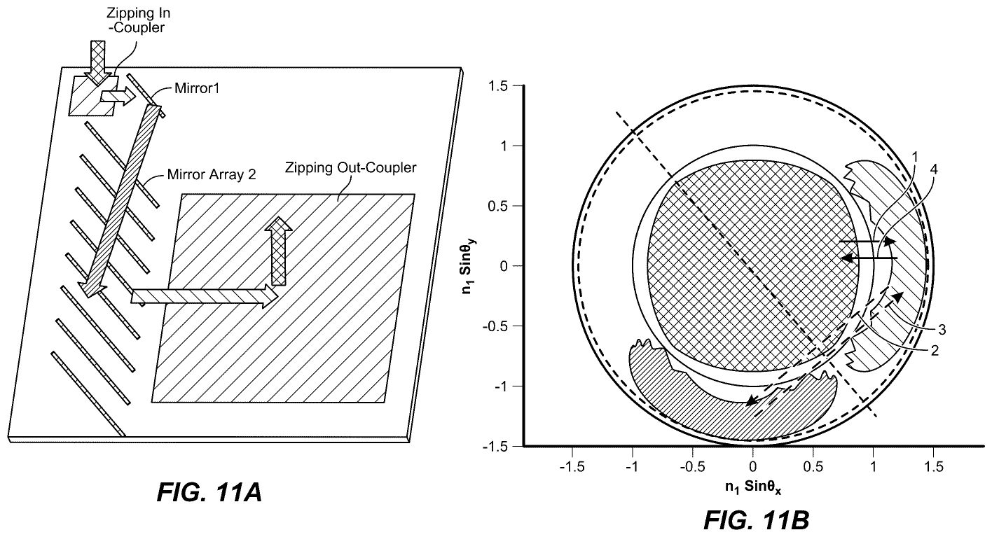

The following will provide, with reference to FIGS. 1A-13, a detailed description of volume Bragg grating (VBG) coupling systems, apparatuses, and methods. The discussion associated with FIGS. 1A-11 relates to the architecture, operation, and manufacturing of various VBG coupling systems and components. The discussion associated with FIGS. 10 and 11 relates to exemplary virtual reality and augmented reality devices that may include VBG coupling systems and apparatuses as disclosed herein.

FIG. 1 illustrates a 1D exit pupil expansion (EPE) waveguide structure, in accordance with various embodiments. The illustrated structure includes a waveguide having a refractive index n₁ that is 1.5, which is the refractive index of a commonly used and relatively inexpensive material. The diffractive in-coupler and out-coupler may be substantially identical and positioned in opposite directions to compensate for each other's chromatic aberrations. Disclosed embodiments may maximize the FOV that can be delivered in this structure.

In at least one example, the in- and out-couplers may be general diffractive gratings (e.g., surface relief gratings) with a single surface period of Λ. Then, the guiding angle θ_{g} may be determined by the following diffraction law equation:

$$\frac{2 π {n}_{1}}{λ} sin {θ}_{g} = \frac{2 π {n}_{1}}{λ} sin ( - {θ}_{o} ) + \frac{2 π}{Λ} \qquad ( Eq . 1 )$$

The guiding angle θ_{g} must be greater than the critical angle for total internal reflection (TIR) conditions and less than a certain angle (ex. 75°) for the density of replicated exit pupils.

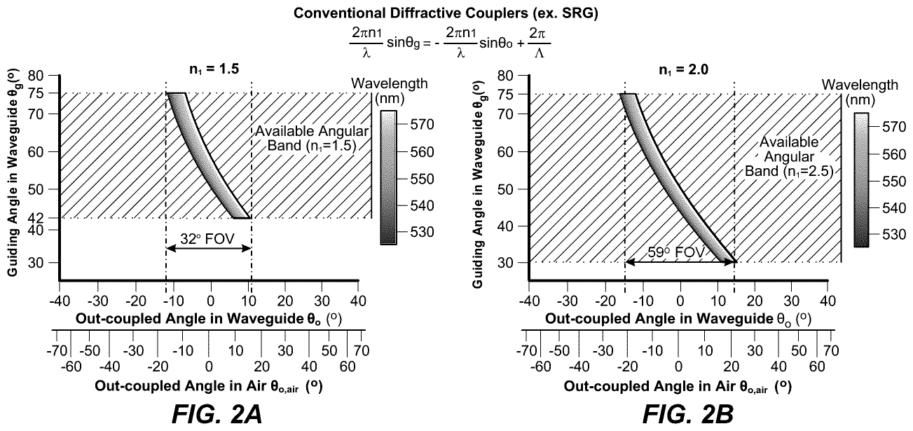

FIG. 2A shows the relationship between the out-coupled angle and the guiding angle under the above constraint, which is herein referred to as “the coupling relation.” It can be seen that the range of out-coupled angles, that is, the FOV, is limited to only approximately 29°. This is the main cause of limiting the FOV of the waveguide type augmented reality display.

FIG. 2B shows the coupling relation of a waveguide with a higher refractive index of 2.0. It has a wider range of available guiding angles because of the lower critical angle. Additionally, deflection due to refraction at the waveguide surface may also be larger, resulting in a wider FOV.

Using a higher-index medium may be the most traditionally straightforward method to increase FOV. However, it can be a very expensive method and it may still result in a limited FOV when utilized in a conventional waveguide structure.

In FIGS. 2A and 2B, the slopes of the curves are determined to a certain value by the diffraction law of Equation 1, which may be impossible to change. If it were possible change the curve slopes, such a change would break a basic principle of optics, namely etendue conservation. Assuming, however, that it were possible to have a coupling relation with a lower slope of ⅓, then the following equation would apply:

$$\frac{2 π {n}_{1}}{λ} sin {θ}_{g} = \frac{1}{3} \times \frac{2 π {n}_{1}}{λ} sin ( - {θ}_{o} ) + \frac{2 π}{Λ} \qquad ( Eq . 2 )$$

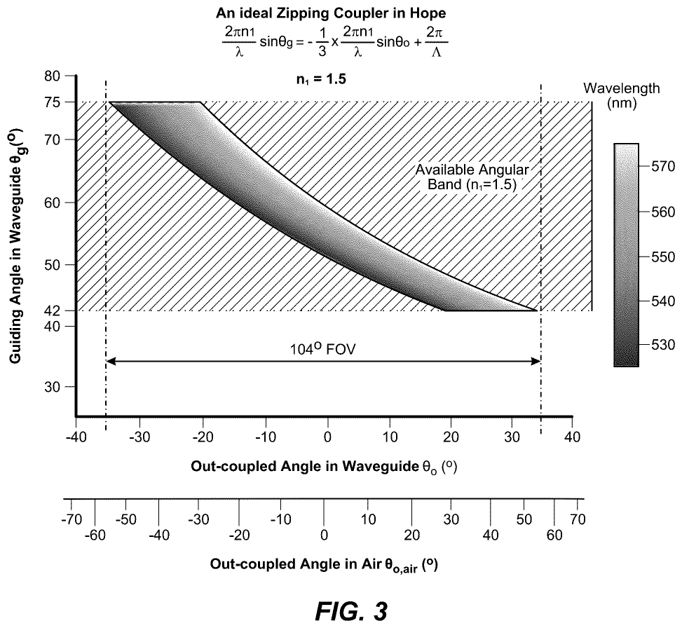

FIG. 3 illustrates an ideal zipping coupler that adheres to Equation 2. As can be seen in this figure, a wider out-coupled angle range can be delivered under the same guiding angle limit. In other words, the in-coupler may compress the wide FOV into a narrow guiding angle range, and the out-coupler may then unzip this guiding angle range again to create a wide FOV. In this document, a coupler with this function is referred to as a “zipping coupler”.

This “zipping coupler” approach is different from previous studies in that a wide FOV can be achieved through a coupler design without a high index material. In other words, it is a method to improve the coupling relation, not the limit of the guiding angle, among the two causes of the limited FOV.

As noted above, a zipping coupler with the coupling relation of Equation 2 cannot theoretically exist. However, the systems disclosed herein may implement a practically equivalent coupling relation using VBG waveguides.

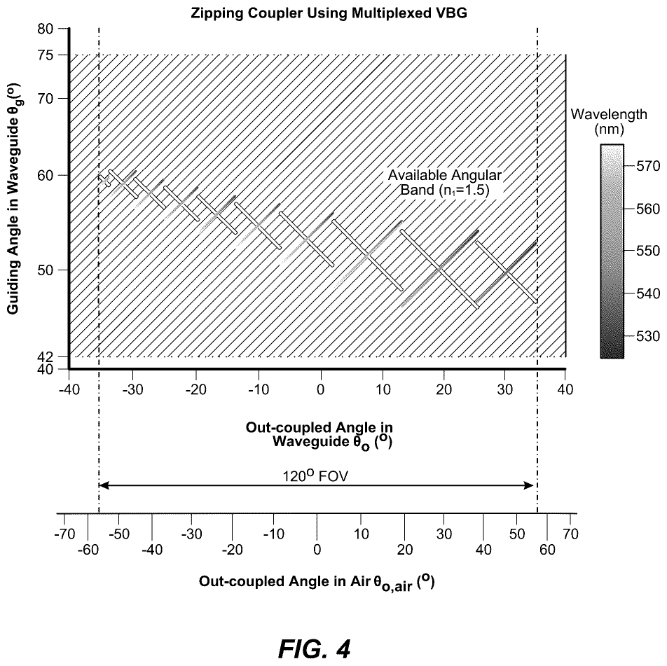

FIG. 4 shows a coupling relation of a zipping coupler that utilizes a multiplexed VBG waveguide. VBG waveguides may have two very specific and useful properties: 1) high angular/spectral selectivity and 2) capability of multiplexing. The properties enable a design space with a high degree of freedom.

FIG. 4 shows an example of the coupling relation of a properly designed VBG zipping coupler, which includes multiple segments. Looking first at the individual segments, each segment of the VBG zipping coupler represented in FIG. 4 may correspond to a single grating in multiplexed gratings. Because of the high selectivity of a single VBG, the coupling relation is no longer a wide band with a range of wavelengths (see FIGS. 2A-3). Rather, the coupling relation for each segment is a curved line with a varying wavelength. This curve represents a pair of angles and wavelengths that satisfy the Bragg matching condition.

Looking next look at the combination of segments. The out-coupled angles of the left and right ends of each segment are in contact with each other. So, all out-coupled angles within 120 deg FOV are related to one guiding angle. This relationship is not a 1:1 mapping of course, but even out-coupled angles with the same guiding angle have different wavelengths, so they do not create cross-talk with each other. As a result, it is possible to cover a wide FOV using a limited guiding angle, although it has a slightly different wavelength depending on the out-coupled angle within the FOV.

In practice, this coupling relation curve also has a finite narrow bandwidth. So, the wavelength difference at two different points with the same guiding angle must be wider than this bandwidth. The design principle taking this into account is described in the following section.

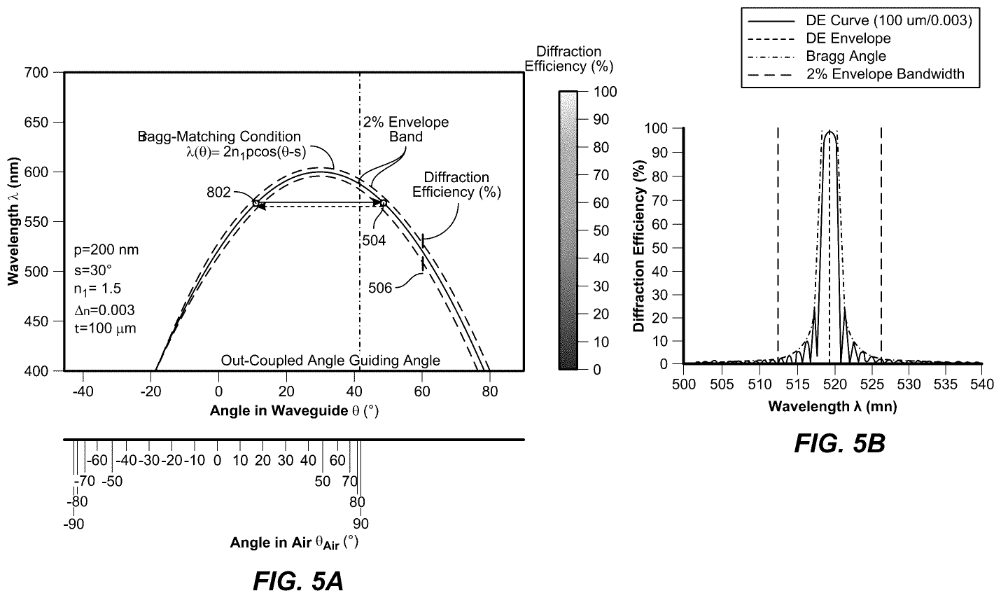

FIGS. 5A and 5B show the coupling relation in another domain for a single VBG. Here, the vertical axis is the spectrum and the horizontal axis is the angle. The angle on the horizontal axis represents both the out-coupled angle and the guiding angle. In this domain, it can be seen that the diffraction efficiency of a single VBG is high only near a certain curve. This Bragg matching condition curve of VBG becomes the following cosine function and is indicated by the solid curve in FIG. 5A:

λ(θ)=2n₁p cos (θ−s) (Eq. 3)

For one wavelength, two θs create a Bragg-matching condition. Among these pairs, the one smaller than the critical angle becomes the out-coupled angle θₒ, and the rest becomes the guiding angle θ_{g}. That is, when incident at an angle corresponding to point 502 in FIG. 5A, the diffracted angle becomes point 504, and vice versa.

Plotting this narrow band for a fixed angle near the vertical solid line 506 in FIG. 5A gives the graph shown in FIG. 5B, which has periodic ripples. For convenience of calculation, the envelope may be considered to ignore this ripple. The region where the width of the part where the diffraction efficiency value of this envelope is more than 2% is called the bandwidth, and it is expressed as the following formula (and is indicated by the two dashed lines in FIG. 5B).

$$Δ λ = \pm \frac{1}{\sqrt{0.02}} \times \frac{Δ np}{cos ( {θ}_{in} - s )} \times \sqrt{\frac{cos {θ}_{out}}{cos {θ}_{in}}} \qquad ( Eq . 4 )$$

The disclosed zipping VBG couplers may be designed using Equations 3 and 4. Multiple pairs of grating pitch p and slant angle s can represent a multiplexed VBG.

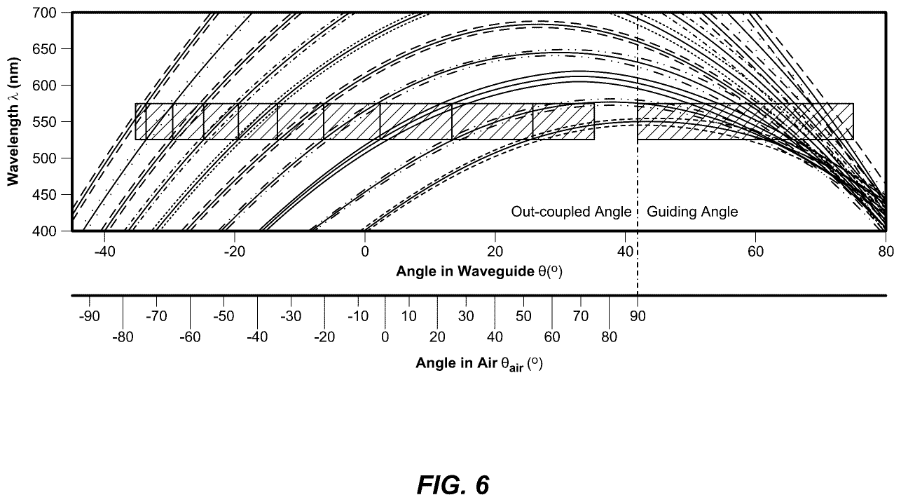

FIG. 6 shows a properly designed angle-spectrum coupling relation of a VBG waveguide, in accordance with some embodiments. It is assumed for this example that the spectrum of the light source is between 525 nm and 575 nm. There are two rules that must be satisfied. First rule: no curves should cross each other within the light source's spectrum range. More specifically, no Bragg-matching curve must exist within the bandwidth of the other curve. Otherwise, crosstalk is very likely to occur. Second rule: The union of the out-coupled angle ranges of each segment curve should cover the entire FOV without blanks. Otherwise, there are likely to be some empty areas in the FOV.

In the guiding angle range, the curve of each grating should be positioned as densely as possible to utilize the limited guiding angle range efficiently. The first rule determines the minimum gap at this time. In the out-coupled angle range, the Bragg-matching curves of each grating should be arranged as sparsely as possible to cover a large FOV. The second rule sets the maximum gap at this time.

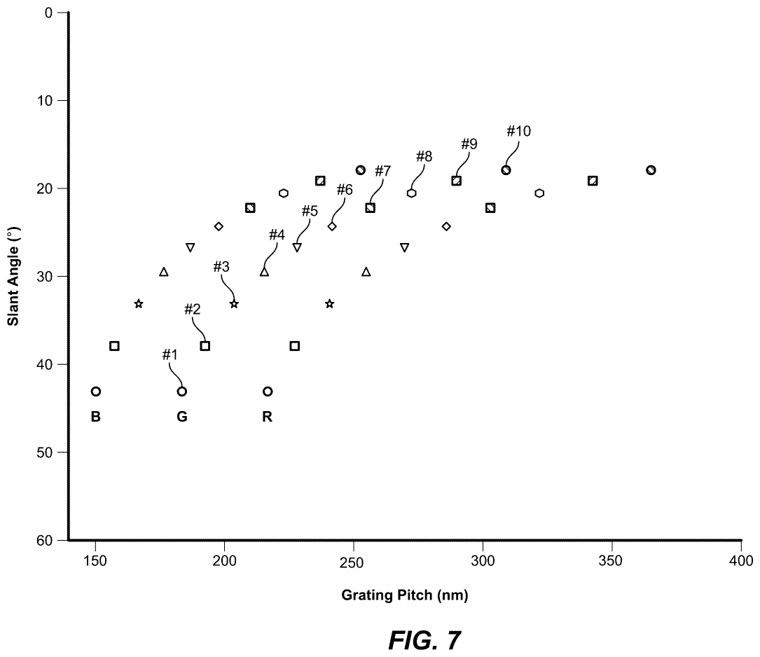

The zipping function becomes possible because the spacing of the Bragg-matching curves is different in the guiding angle range and in the out-coupled angle range. As a result, in the design represented in FIG. 6, an FOV of −60° to +60° can be transmitted using only a guiding angle range of 50° to 72°. The specs of this design are summarized in Table 1 below, which is graphically represented in FIG. 7.

TABLE 1
Specification of properly designed zipping VBG coupler

| | Slant | Grating Pitch (nm) | | |
|---|---|---|---|---|
| | Angle | Blue | Green | Red |
| No. | (°) | 430 nm~470 nm | 525 nm~575 nm | 620 nm~680 nm |
| #1 | 43 | 150 | 183.3333 | 216.6666 |
| #2 | 37.8293 | 157.2605 | 192.2073 | 227.1541 |
| #3 | 33.1043 | 166.5713 | 203.5872 | 240.6031 |
| #4 | 29.561 | 176.2952 | 215.4719 | 254.6486 |
| #5 | 26.7052 | 186.6373 | 228.1123 | 269.5873 |
| #6 | 24.3306 | 197.7321 | 241.6726 | 285.6131 |
| #7 | 22.3277 | 209.711 | 256.3135 | 302.916 |
| #8 | 20.6312 | 222.7247 | 272.2191 | 321.7135 |
| #9 | 19.2003 | 236.96 | 289.6178 | 342.2756 |
| #10 | 18.01 | 252.6611 | 308.808 | 364.9549 |

| | |
|---|---|
| Average refractive index change n₁ | 1.5 |
| Refractive index change Δn₁ | 0.003 for each |
| | 0.03 in total |
| Thickness t | 100 μm |

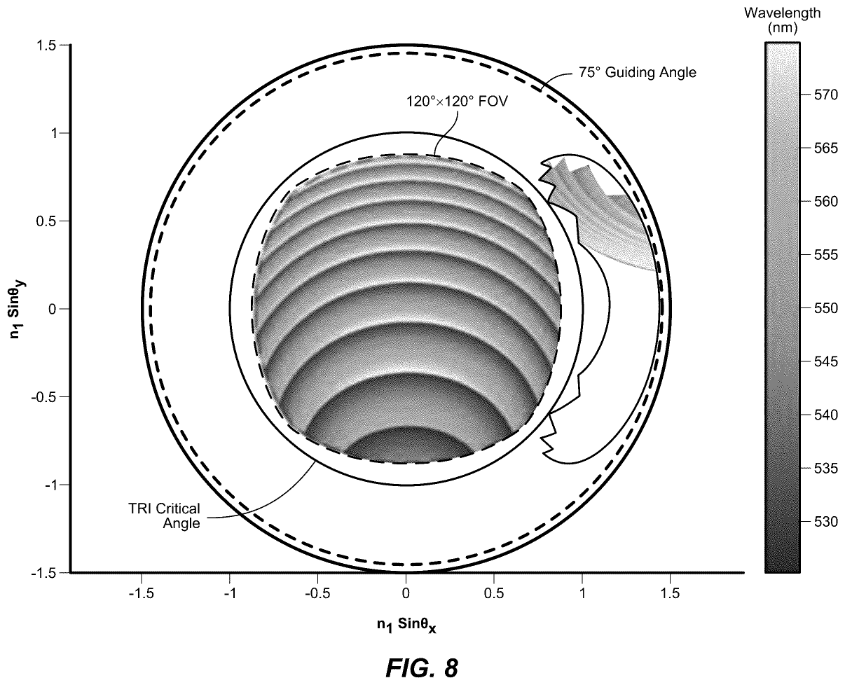

In the above description, 1D FOV along the x-axis has been considered. In the following section, 2D angular space along xy-space will be considered. FIG. 8 shows Bragg matching wavelength at each position in 2D out-coupled angular space.

As can be seen in FIG. 8, all out-coupled angles within 120°×120° FOV have Bragg matching conditions and corresponding guiding angles are within the available 75° guiding angular band. Accordingly, the second rule is still satisfied.

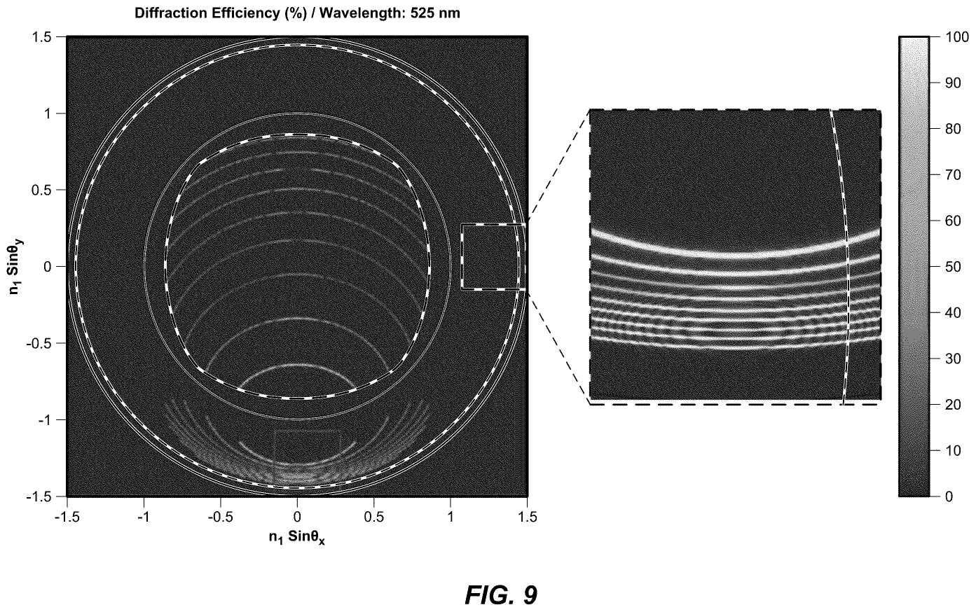

FIG. 9 illustrates Bragg matching bands in 2D guiding angle space, in accordance with at least one example. It is quite difficult to express the first rule regarding cross-talk directly in 2D angular space. This is because it is necessary to check that each volume band does not overlap in 3D space (2D angle×1D spectrum). However, as illustrated in FIG. 6, if each band does not overlap at the shortest wavelength, this condition is naturally satisfied at the longer wavelength. This is the same in 2D angular space. Therefore, as illustrated in FIG. 9, the band at 525 nm (the shortest wavelength in the spectrum) is displayed in 2D angular space.

In FIG. 9, it can be seen that each band still does not overlap each other in the guiding angle range even in 2D angular space. Thus, the first rule is still satisfied. The disclosed VBG waveguide designs avoid crosstalk by placing each band so that they do not overlap each other. However, since these bands are based on 2% diffraction efficiency, a simulation may be utilized to determine how strong the crosstalk might actually be.

FIGS. 10A-10C show the intensity distribution in 2D angle space after passing through both the zipping in-coupler and out-coupler of a disclosed VBG coupler. The crosstalk between multiplexed gratings may create ghost images. However, the intensity of the ghost images may be relatively weak compared to the signal. According to the simulation represented by FIGS. 10A-10C, the signal-to-noise ratio (SNR) based on total energy is approximately 100:1.

Since VBG zipping couplers use high spectral selectivity, if the spectral bandwidth of the light source is too wide, only a part of it can be transmitted. That is, the light efficiency will decrease. On the other hand, as shown in FIG. 8, the required central wavelength may vary according to the angle within the FOV. Therefore, an optimized light source may be desired for the disclosed systems to have sufficiently high efficiency. Ideally, a scanning mirror combined with a tunable wavelength laser would satisfy such optimized light source requirements. However, this may be difficult to implement in reality. Additionally or alternatively, using multiple lasers with different wavelengths within the target spectrum may provide a more practical light source for use in zipping VBG systems.

A VBG zipping coupler, as described herein, necessarily accompanies color nonuniformity because different wavelengths are transmitted differently depending on the angle within the FOV, even within one color channel. Therefore, post-compensation for such angular transmission differences may be necessary to achieve a desired output. Through this post-compensation, the output light will have a narrower color gamut than a system using a laser. However, it can still be a wide enough color gamut for a typical display system.

In the previous sections, only a green channel (525 nm˜575 nm) was analyzed. In some embodiments, a single zipping VBG design may be utilized to cover all three RGB wavelengths. Additionally or alternatively, three separate VBG waveguides (one for each of the three RGB wavelength ranges) may be stacked.

Each color channel VBG may have the same slant angle as shown in FIG. 7. The grating pitch is proportional to each central wavelength. This is because in Equations 3 and 4, the relationship between wavelength and pitch is always proportional. Therefore, the required spectral bandwidth for each color is also proportional to each central wavelength.

FIGS. 11A and 11B illustrate a potential 2D EPE waveguide using a mixed waveguide and its associated k-space diagram. All the analyses presented above are primarily for 1D waveguides, but the same principles can be applied to 2D EPE waveguides. However, there are two more things to consider at this time.

First, the added middle grating should cover a wide and irregular-shaped angular band as shown in FIG. 8 as well as a wide spectral range. Reflection mirrors may be utilized as a middle grating that satisfies these requirements. Accordingly, a mixed waveguide that combines VBG and reflection mirrors would likely be appropriate. FIG. 11A is the expected schematic for such a configuration. Additionally, FIG. 11B illustrates the expected k-space angular-domain diagram for this configuration.

Second, the diffraction efficiency of the out-coupler should be intentionally made much lower. For this, a design change may be required to reduce the refractive index modulation Δn of the grating or the thickness t. Looking at Equations 3 and 4, there is no need to change the design for the slant angle or grating pitch because the Bragg matching condition and its bandwidth are independent of Δn or t. However, since maximum diffraction efficiency is reduced, bandwidth based on 2% efficiency may not be sufficient for a high SNR.

The designs described in the preceding sections as properly designed zipping VBG couplers include certain assumptions that may varied as necessary. For example, the spectral bandwidth was set to 50 nm, the VBG thickness was set to 100 μm, and the maximum refractive index modulation was set to 0.03. 120°×120° of target FOV, 1.5 refractive index, and usable guiding angle range under 75° are also arbitrarily selected values. All of these values may be changed or limited as needed.

As discussed herein, the present disclosure is generally directed to display systems, devices, and methods that include zipping VBG couplers. Optimized VBG couplers can deliver a wide FOV beyond conventional limits utilizing even relatively low-refractive index waveguide materials. Wide FOVs (e.g., approximately)120°×120°) may be achieved with a waveguide having a refractive index as low as approximately 1.5. Low-cost, wide-FOV waveguides are therefore achievable with the presently disclosed systems. Optimized light sources may additionally be utilized for maximum system efficiency.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

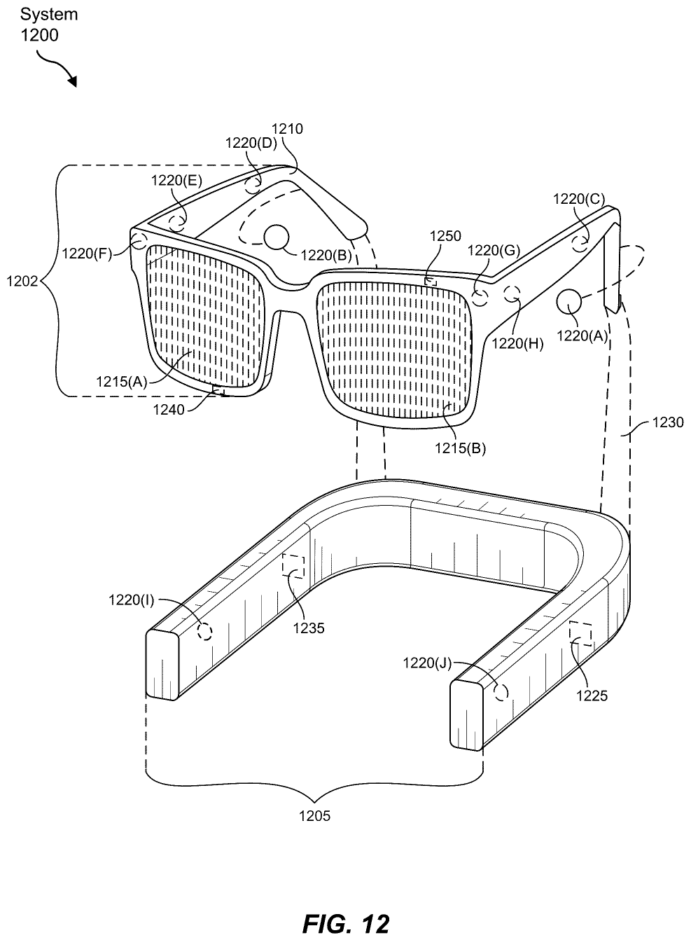

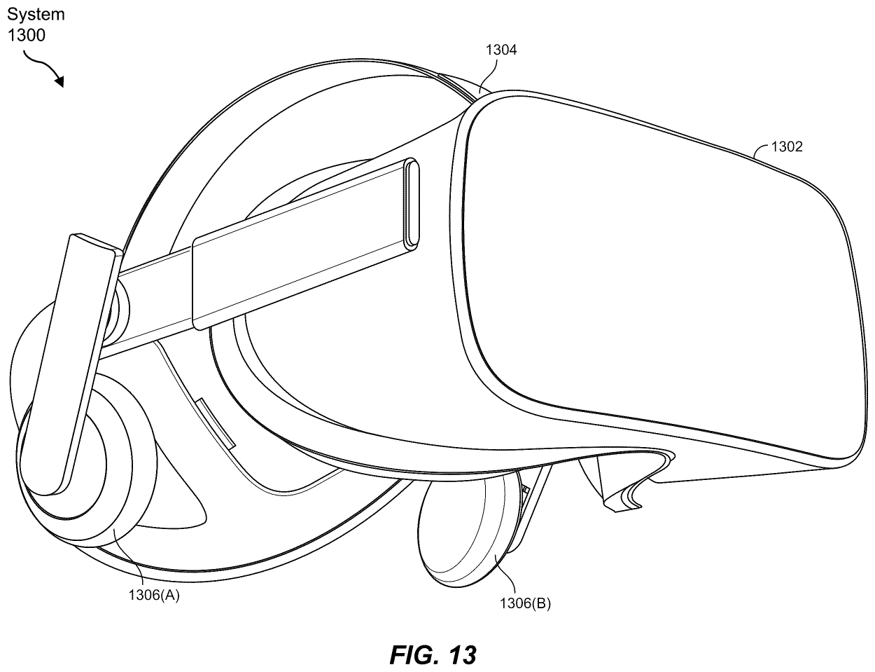

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1200 in FIG. 12) or that visually immerses a user in an artificial reality (such as, e.g., virtual-reality system 1300 in FIG. 13). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 12, augmented-reality system 1200 may include an eyewear device 1202 with a frame 1210 configured to hold a left display device 1215(A) and a right display device 1215(B) in front of a user's eyes. Display devices 1215(A) and 1215(B) may act together or independently to present an image or series of images to a user. While augmented-reality system 1200 includes two displays, embodiments of this disclosure may be implemented in augmented-reality systems with a single NED or more than two NEDs.

In some embodiments, augmented-reality system 1200 may include one or more sensors, such as sensor 1240. Sensor 1240 may generate measurement signals in response to motion of augmented-reality system 1200 and may be located on substantially any portion of frame 1210. Sensor 1240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1200 may or may not include sensor 1240 or may include more than one sensor. In embodiments in which sensor 1240 includes an IMU, the IMU may generate calibration data based on measurement signals from sensor 1240. Examples of sensor 1240 may include, without limitation, accelerometers, gyroscopes, magnetometers, other suitable types of sensors that detect motion, sensors used for error correction of the IMU, or some combination thereof.

In some examples, augmented-reality system 1200 may also include a microphone array with a plurality of acoustic transducers 1220(A)-1220(J), referred to collectively as acoustic transducers 1220. Acoustic transducers 1220 may represent transducers that detect air pressure variations induced by sound waves. Each acoustic transducer 1220 may be configured to detect sound and convert the detected sound into an electronic format (e.g., an analog or digital format). The microphone array in FIG. 12 may include, for example, ten acoustic transducers: 1220(A) and 1220(B), which may be designed to be placed inside a corresponding ear of the user, acoustic transducers 1220(C), 1220(D), 1220(E), 1220(F), 1220(G), and 1220(H), which may be positioned at various locations on frame 1210, and/or acoustic transducers 1220(I) and 1220(J), which may be positioned on a corresponding neckband 1205.

In some embodiments, one or more of acoustic transducers 1220(A)-(J) may be used as output transducers (e.g., speakers). For example, acoustic transducers 1220(A) and/or 1220(B) may be earbuds or any other suitable type of headphone or speaker.

The configuration of acoustic transducers 1220 of the microphone array may vary. While augmented-reality system 1200 is shown in FIG. 12 as having ten acoustic transducers 1220, the number of acoustic transducers 1220 may be greater or less than ten. In some embodiments, using higher numbers of acoustic transducers 1220 may increase the amount of audio information collected and/or the sensitivity and accuracy of the audio information. In contrast, using a lower number of acoustic transducers 1220 may decrease the computing power required by an associated controller 1250 to process the collected audio information. In addition, the position of each acoustic transducer 1220 of the microphone array may vary. For example, the position of an acoustic transducer 1220 may include a defined position on the user, a defined coordinate on frame 1210, an orientation associated with each acoustic transducer 1220, or some combination thereof.

Acoustic transducers 1220(A) and 1220(B) may be positioned on different parts of the user's ear, such as behind the pinna, behind the tragus, and/or within the auricle or fossa. Or, there may be additional acoustic transducers 1220 on or surrounding the ear in addition to acoustic transducers 1220 inside the ear canal. Having an acoustic transducer 1220 positioned next to an ear canal of a user may enable the microphone array to collect information on how sounds arrive at the ear canal. By positioning at least two of acoustic transducers 1220 on either side of a user's head (e.g., as binaural microphones), augmented-reality device 1200 may simulate binaural hearing and capture a 3D stereo sound field around about a user's head. In some embodiments, acoustic transducers 1220(A) and 1220(B) may be connected to augmented-reality system 1200 via a wired connection 1230, and in other embodiments acoustic transducers 1220(A) and 1220(B) may be connected to augmented-reality system 1200 via a wireless connection (e.g., a BLUETOOTH connection). In still other embodiments, acoustic transducers 1220(A) and 1220(B) may not be used at all in conjunction with augmented-reality system 1200.

Acoustic transducers 1220 on frame 1210 may be positioned in a variety of different ways, including along the length of the temples, across the bridge, above or below display devices 1215(A) and 1215(B), or some combination thereof. Acoustic transducers 1220 may also be oriented such that the microphone array is able to detect sounds in a wide range of directions surrounding the user wearing the augmented-reality system 1200. In some embodiments, an optimization process may be performed during manufacturing of augmented-reality system 1200 to determine relative positioning of each acoustic transducer 1220 in the microphone array.

In some examples, augmented-reality system 1200 may include or be connected to an external device (e.g., a paired device), such as neckband 1205. Neckband 1205 generally represents any type or form of paired device. Thus, the following discussion of neckband 1205 may also apply to various other paired devices, such as charging cases, smart watches, smart phones, wrist bands, other wearable devices, hand-held controllers, tablet computers, laptop computers, other external compute devices, etc.

As shown, neckband 1205 may be coupled to eyewear device 1202 via one or more connectors. The connectors may be wired or wireless and may include electrical and/or non-electrical (e.g., structural) components. In some cases, eyewear device 1202 and neckband 1205 may operate independently without any wired or wireless connection between them. While FIG. 12 illustrates the components of eyewear device 1202 and neckband 1205 in example locations on eyewear device 1202 and neckband 1205, the components may be located elsewhere and/or distributed differently on eyewear device 1202 and/or neckband 1205. In some embodiments, the components of eyewear device 1202 and neckband 1205 may be located on one or more additional peripheral devices paired with eyewear device 1202, neckband 1205, or some combination thereof.

Pairing external devices, such as neckband 1205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1200 may be provided by a paired device or shared between a paired device and an eyewear device, thus reducing the weight, heat profile, and form factor of the eyewear device overall while still retaining desired functionality. For example, neckband 1205 may allow components that would otherwise be included on an eyewear device to be included in neckband 1205 since users may tolerate a heavier weight load on their shoulders than they would tolerate on their heads. Neckband 1205 may also have a larger surface area over which to diffuse and disperse heat to the ambient environment. Thus, neckband 1205 may allow for greater battery and computation capacity than might otherwise have been possible on a stand-alone eyewear device. Since weight carried in neckband 1205 may be less invasive to a user than weight carried in eyewear device 1202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1205 may be communicatively coupled with eyewear device 1202 and/or to other devices. These other devices may provide certain functions (e.g., tracking, localizing, depth mapping, processing, storage, etc.) to augmented-reality system 1200. In the embodiment of FIG. 12, neckband 1205 may include two acoustic transducers (e.g., 1220(I) and 1220(J)) that are part of the microphone array (or potentially form their own microphone subarray). Neckband 1205 may also include a controller 1225 and a power source 1235.

Acoustic transducers 1220(I) and 1220(J) of neckband 1205 may be configured to detect sound and convert the detected sound into an electronic format (analog or digital). In the embodiment of FIG. 12, acoustic transducers 1220(I) and 1220(J) may be positioned on neckband 1205, thereby increasing the distance between the neckband acoustic transducers 1220(I) and 1220(J) and other acoustic transducers 1220 positioned on eyewear device 1202. In some cases, increasing the distance between acoustic transducers 1220 of the microphone array may improve the accuracy of beamforming performed via the microphone array. For example, if a sound is detected by acoustic transducers 1220(C) and 1220(D) and the distance between acoustic transducers 1220(C) and 1220(D) is greater than, e.g., the distance between acoustic transducers 1220(D) and 1220(E), the determined source location of the detected sound may be more accurate than if the sound had been detected by acoustic transducers 1220(D) and 1220(E).

Controller 1225 of neckband 1205 may process information generated by the sensors on neckband 1205 and/or augmented-reality system 1200. For example, controller 1225 may process information from the microphone array that describes sounds detected by the microphone array. For each detected sound, controller 1225 may perform a direction-of-arrival (DOA) estimation to estimate a direction from which the detected sound arrived at the microphone array. As the microphone array detects sounds, controller 1225 may populate an audio data set with the information. In embodiments in which augmented-reality system 1200 includes an inertial measurement unit, controller 1225 may compute all inertial and spatial calculations from the IMU located on eyewear device 1202. A connector may convey information between augmented-reality system 1200 and neckband 1205 and between augmented-reality system 1200 and controller 1225. The information may be in the form of optical data, electrical data, wireless data, or any other transmittable data form. Moving the processing of information generated by augmented reality system 1200 to neckband 1205 may reduce weight and heat in eyewear device 1202, making it more comfortable to the user.

Power source 1235 in neckband 1205 may provide power to eyewear device 1202 and/or to neckband 1205. Power source 1235 may include, without limitation, lithium ion batteries, lithium-polymer batteries, primary lithium batteries, alkaline batteries, or any other form of power storage. In some cases, power source 1235 may be a wired power source. Including power source 1235 on neckband 1205 instead of on eyewear device 1202 may help better distribute the weight and heat generated by power source 1235.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1300 in FIG. 13, that mostly or completely covers a user's field of view. Virtual-reality system 1300 may include a front rigid body 1302 and a band 1304 shaped to fit around a user's head. Virtual-reality system 1300 may also include output audio transducers 1306(A) and 1306(B). Furthermore, while not shown in FIG. 13, front rigid body 1302 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1200 and/or virtual-reality system 1300 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1200 and/or virtual-reality system 1300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1200 and/or virtual-reality system 1300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

### Systems and Methods for Human-Computer Interaction

Wearable biopotential measurement technologies (e.g., electromyography, electrocardiography) use dry electrodes to record biopotentials from the human body. Biopotential electrodes with low skin-electrode impedance values are desired for improved contact quality, noise performance, and signal quality. However, contact-based health sensing electrodes suffer from the presence of hair on the skin surface. Hair blocks the signal transmission from the skin to the electrode by creating a resistive layer, distorts biopotential signals, and contributes to the baseline noise.

The present disclosure is generally directed to systems and methods for human-computer interaction. The disclosure details development of biopotential electrodes with surface microstructures for improving the hair penetration as well as decreasing the skin electrode contact impedance on the hairy sites of the skin. As will be explained in greater detail below, embodiments of the present disclosure may measure from different angles, by at least one processor and using an imaging technique, skin hair coverage in a skin surface region of a user. Embodiments of the present disclosure may also determine, by the at least one processor and based on the measurements, specifications of biopotential electrodes including microstructures on a surface thereof configured to contact the skin surface region of the user and locations of the biopotential electrodes on a wearable device. Embodiments of the present disclosure may further perform human-computer interaction, by at least one processor, based on biopotential measurements provided by the biopotential electrodes that include microstructures on the surface thereof that are configured to contact the skin surface region of the user.

Embodiments of the present disclosure may perform the human-computer interaction in various ways. For example, the disclosed microstructured electrodes can be applied to any body-worn devices with biopotential recording or stimulation functionalities. In some implementation, the disclosed microstructured electrodes can be used as signal recording electrodes of electromyography (EMG) wristbands. Also, the electrodes on the hairy sites of the wrist (palmar, ulnar, or radial sites) can be replaced with the disclosed microstructured electrodes for improved skin-electrode coupling. Additionally, the disclosed microstructured electrodes can be used as electrodes of chest-worn straps or bands for wellness and fitness monitoring (electrocardiography monitoring, respiration monitoring, lung health monitoring with electrical impedance tomography). In these and other contexts, the microstructured electrodes may improve skin-electrode coupling on the hairy sites of the chest. Further, the disclosed microstructured electrodes can be used as electrodes of disposable or continuous signal recording or stimulation patches. Further, the disclosed microstructured electrodes can be used as electrodes of impedance plethysmography (IPG) devices for continuous blood pressure monitoring, electrodes of total or local skin hydration or perspiration monitoring, and/or electrodes of other wearable stimulation or therapeutic applications (e.g., cancer). Further, the disclosed microstructured electrodes can be used as biopotential recording electrodes of AR/VR/MR glasses and headsets. In some implementations, the microstructured electrodes can be integrated on the temple of eyeglasses or other parts of headsets to interface with the hairy sites on the head to record health biometrics.

Features from any of the embodiments described herein may be used in combination with one another in accordance with the general principles described herein. These and other embodiments, features, and advantages will be more fully understood upon reading the following detailed description in conjunction with the accompanying drawings and claims.

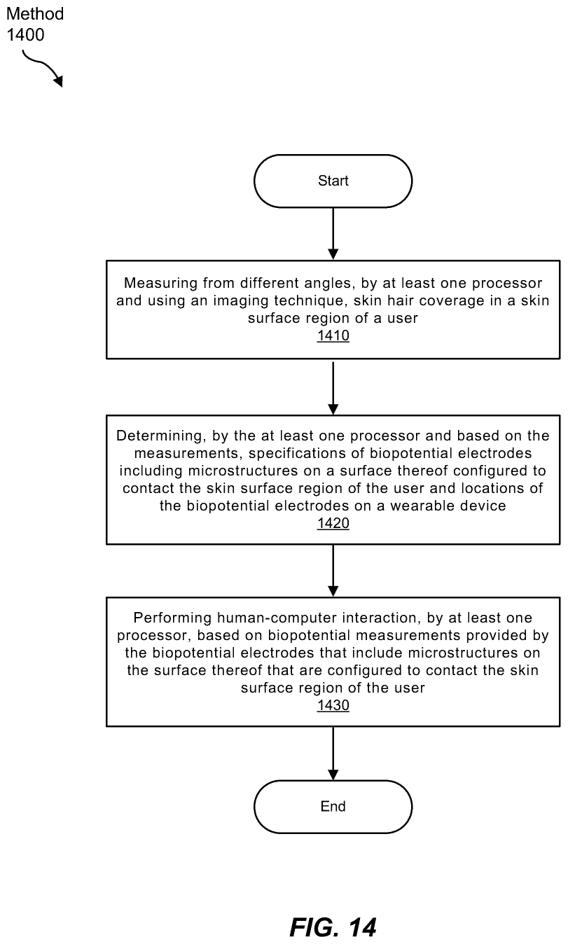

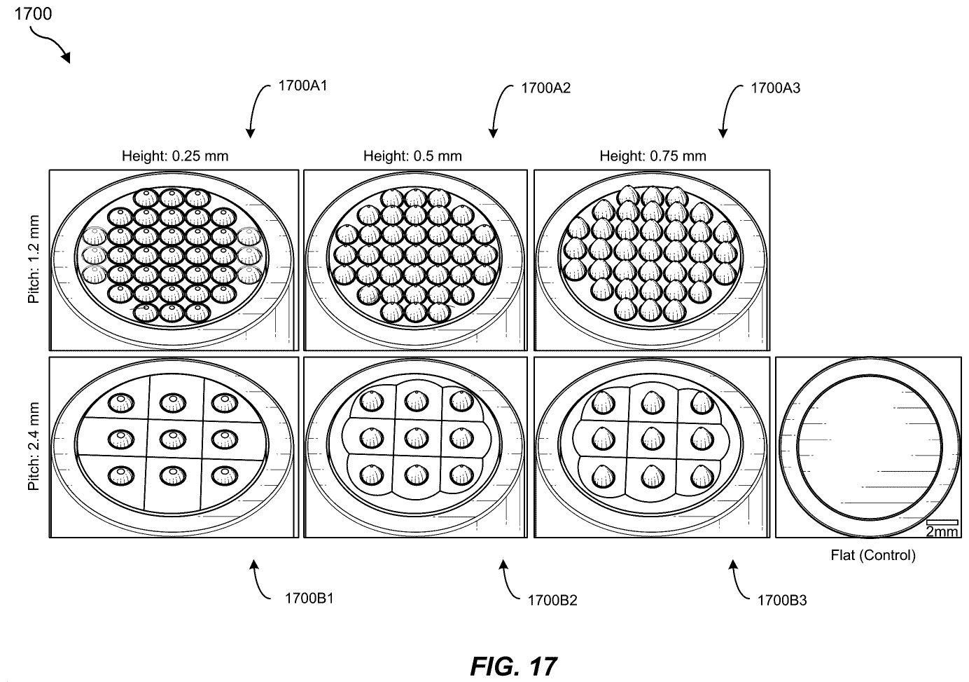

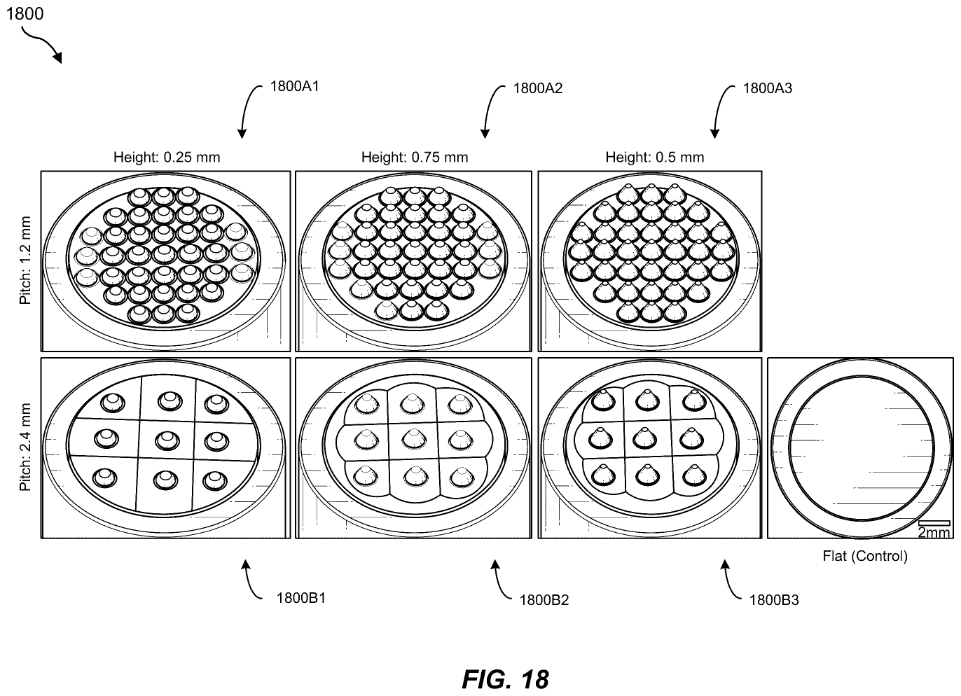

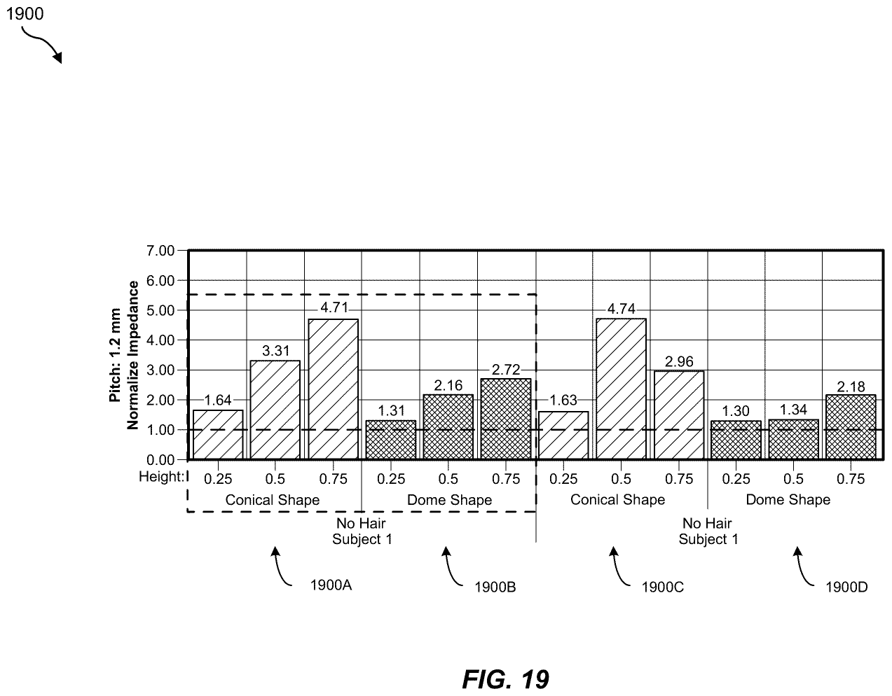

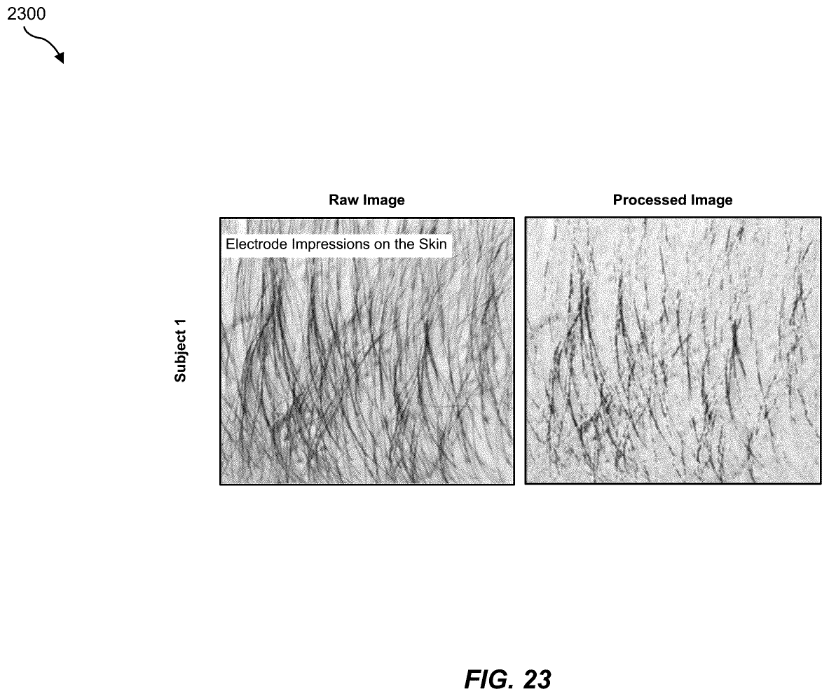

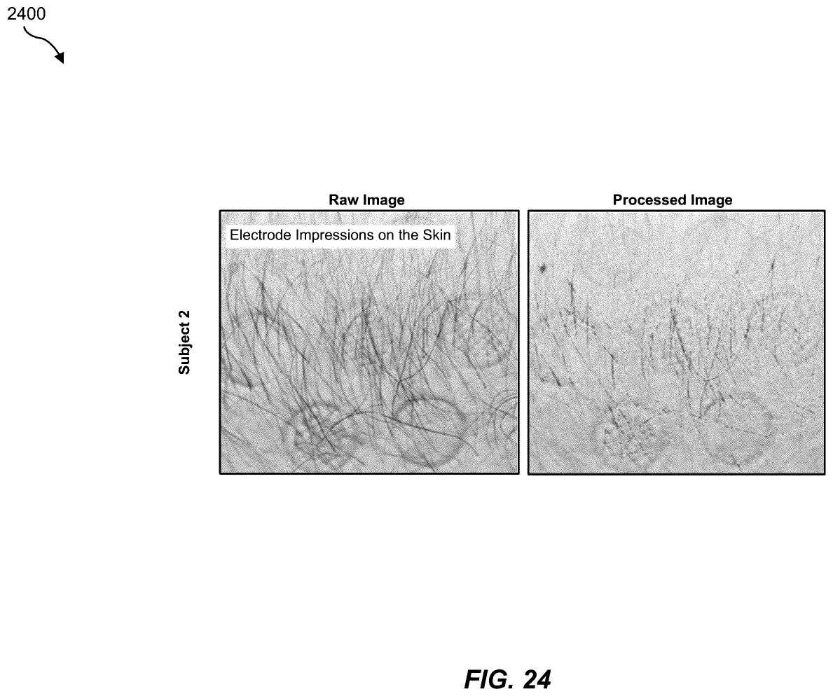

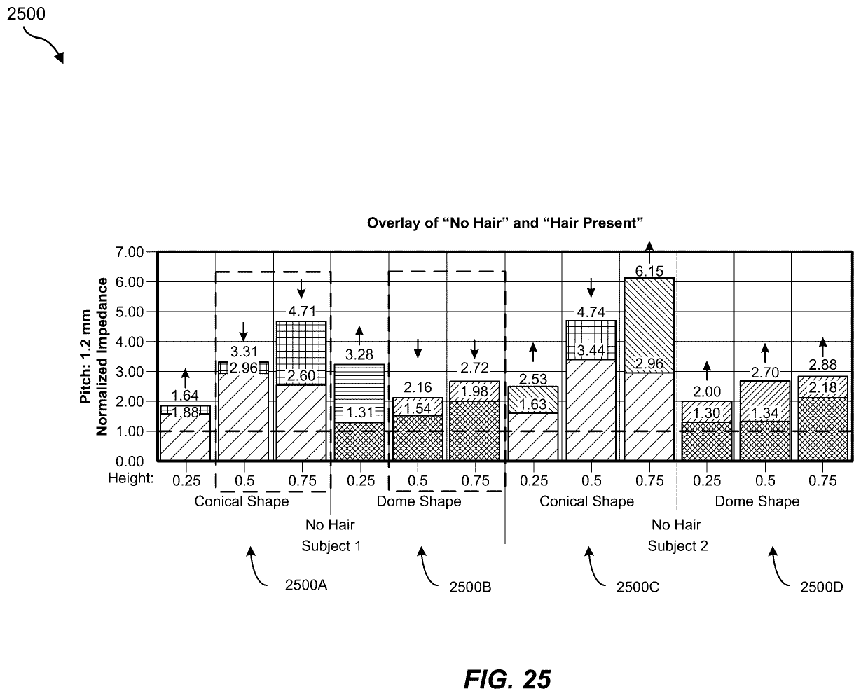

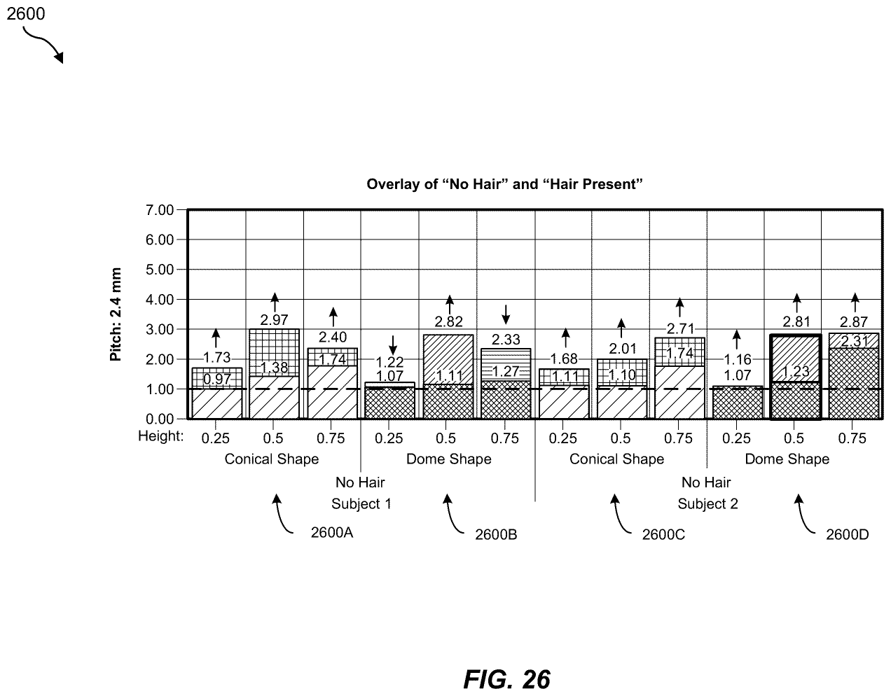

The following will provide, with reference to FIGS. 14-20, detailed descriptions of systems and methods for human-computer interaction. For example, detailed descriptions of exemplary systems and methods for human-computer interaction will be provided in connection with FIGS. 14-16. Additionally, detailed descriptions of exemplary microelectrodes for human-computer interaction will be provided in connection with FIGS. 17 and 18. Also, detailed descriptions of exemplary effects of microstructure characteristics will be provided in connection with FIGS. 19-22. Further, detailed descriptions of exemplary hair coverage in user skin regions will be provided in connection with FIGS. 23 and 24. Further, detailed descriptions of exemplary effects of hair coverage in user skin regions will be provided in connection with FIGS. 25 and 26. Further, detailed descriptions of various applications of the disclosed microstructured electrodes will be provided in connection with FIGS. 14-20.

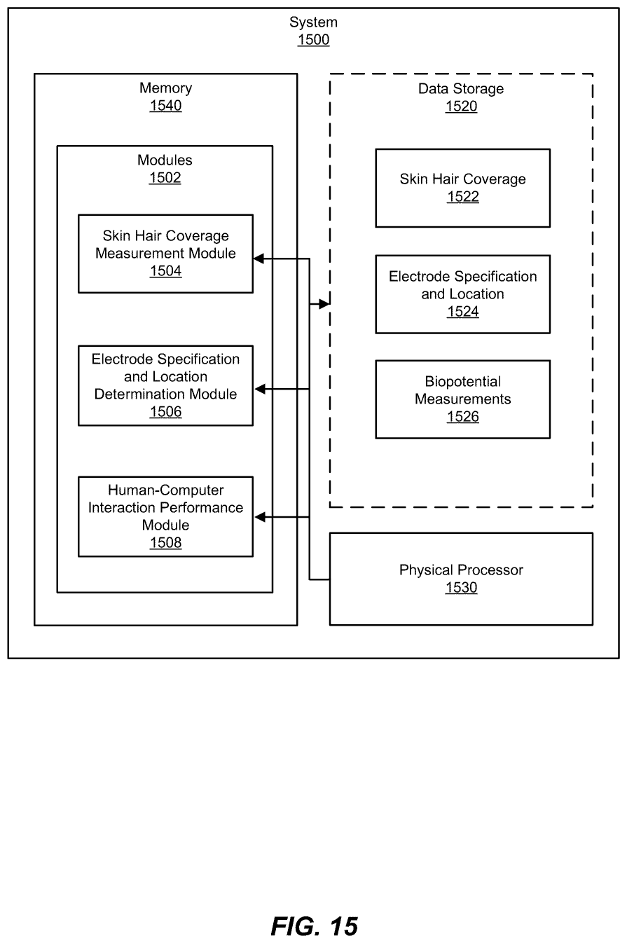

FIG. 14 is a flow diagram of an exemplary computer-implemented method 1400 for human-computer interaction. The steps shown in FIG. 14 may be performed by any suitable computer-executable code and/or computing system, including the system(s) illustrated in FIGS. 15 and/or 16. In one example, each of the steps shown in FIG. 14 may represent an algorithm whose structure includes and/or is represented by multiple sub-steps, examples of which will be provided in greater detail below.

As illustrated in FIG. 14, at step 1410 one or more of the systems described herein may measure skin hair coverage. For example, skin hair coverage management module 1404, as part of system 1500 in FIG. 15, may measure from different angles, by at least one processor and using an imaging technique, skin hair coverage in a skin surface region of a user.

At step 1420, one or more of the systems described herein may determine specifications and locations of biopotential electrodes. For example, electrode specification and location determination module 1406, as part of system 1500 in FIG. 15, may determine, by the at least one processor and based on the measurements, specifications of biopotential electrodes including microstructures on a surface thereof configured to contact the skin surface region of the user and locations of the biopotential electrodes on a wearable device.

At step 1430, one or more of the systems described herein may perform human-computer interaction. For example, human-computer interaction performance module 1408, as part of system 1500 in FIG. 15, may perform human-computer interaction, by at least one processor, based on biopotential measurements provided by the biopotential electrodes that include microstructures on the surface thereof that are configured to contact the skin surface region of the user.

A system for human-computer interaction may be implemented in any suitable manner. Turning to FIG. 15, an exemplary system 1500 includes at least one physical processor 1530, physical memory 1540 comprising computer-executable instructions such as modules 1502, and data storage 1520, such as skin hair coverage 1522, electrode specification and location 1524, and biopotential measurements 1526. When executed by the physical processor 1530, the modules 1502 cause physical processor 1530 to carry out various operations. For example, skin hair coverage measurement module 1504 may execute procedures described above with reference to step 1410 of method 1400 of FIG. 14. Additionally, electrode specification and location determination module 1506 may execute procedures described above with reference to step 1420 of method 1400 of FIG. 14. Also, human-computer interaction performance module 1508 may execute procedures described above with reference to step 1430 of method 1400 of FIG. 14.

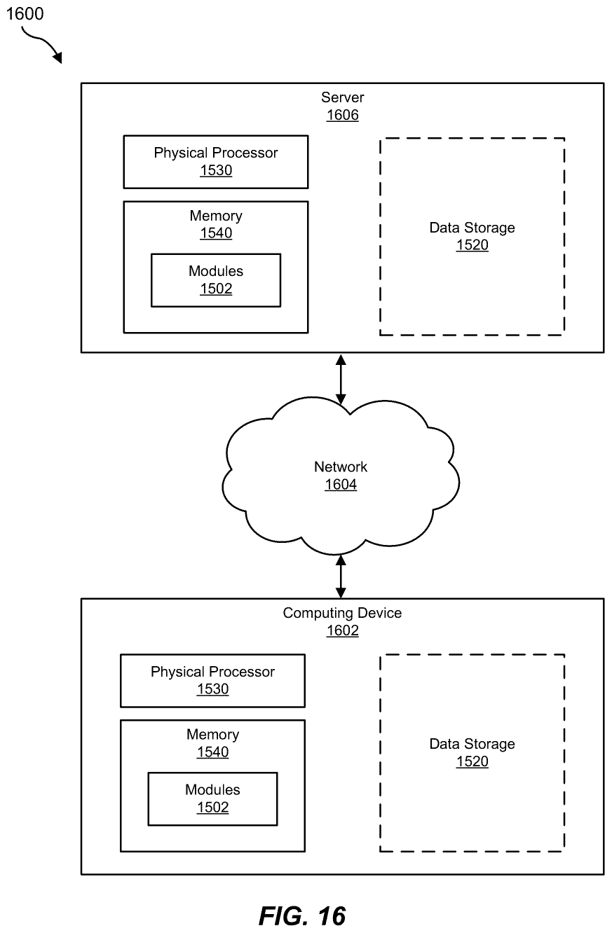

Example system 1500 in FIG. 15 may be implemented in a variety of ways. For example, all or a portion of example system 1500 may represent portions of example system 1600 in FIG. 16. As shown in FIG. 16, system 1600 may include a computing device 1602 in communication with a server 1606 via a network 1604. In one example, all or a portion of the functionality of modules 1502 may be performed by computing device 1602, server 1606, and/or any other suitable computing system. As will be described in greater detail below, one or more of modules 1502 from FIG. 15 may, when executed by at least one processor of computing device 1602 and/or server 1606, enable computing device 1602 and/or server 1606 to perform human-computer interaction. For example, and as will be described in greater detail below, one or more of modules 1502 may cause computing device 1602 and/or server 1606 to perform human-computer interaction based on biopotential measurements provided by biopotential electrodes that include microstructures on the surface thereof that are configured to contact a skin surface region of a user.

Referring to FIG. 17, the disclosed microstructured electrodes may include dome-shaped microelectrodes 1700 for human-computer interaction. For example, dome-shaped microelectrodes 1700A1-1700A3 may have a pitch of 1.2 mm and heights ranging from 0.25 mm to 0.75 mm. Alternatively, dome-shaped microelectrodes 1700B1-1700B3 may have a pitch of 2.4 mm and heights ranging from 0.25 mm to 0.75 mm.

Referring to FIG. 18, the disclosed microstructured electrodes may include conical-shaped microelectrodes 1800 for human-computer interaction. For example, conical-shaped microelectrodes 1800A1-1800A3 may have a pitch of 1.2 mm and heights ranging from 0.25 mm to 0.75 mm. Alternatively, conical-shaped microelectrodes 1800B1-1800B3 may have a pitch of 2.4 mm and heights ranging from 0.25 mm to 0.75 mm.

Referring to FIG. 19, effects 1900 of heights on impedance at 1.2 mm pitch for microstructures of electrodes for human-computer interaction are shown. For example, effects 1900A and 1900C demonstrate impedance experienced with different users with absence of hair and employing conical-shaped electrodes having heights ranging from 0.25 mm to 0.75 mm. Additionally, effects 1900B and 1900D demonstrate impedance experienced with the different users with absence of hair and employing dome-shaped electrodes having heights ranging from 0.25 mm to 0.75 mm.

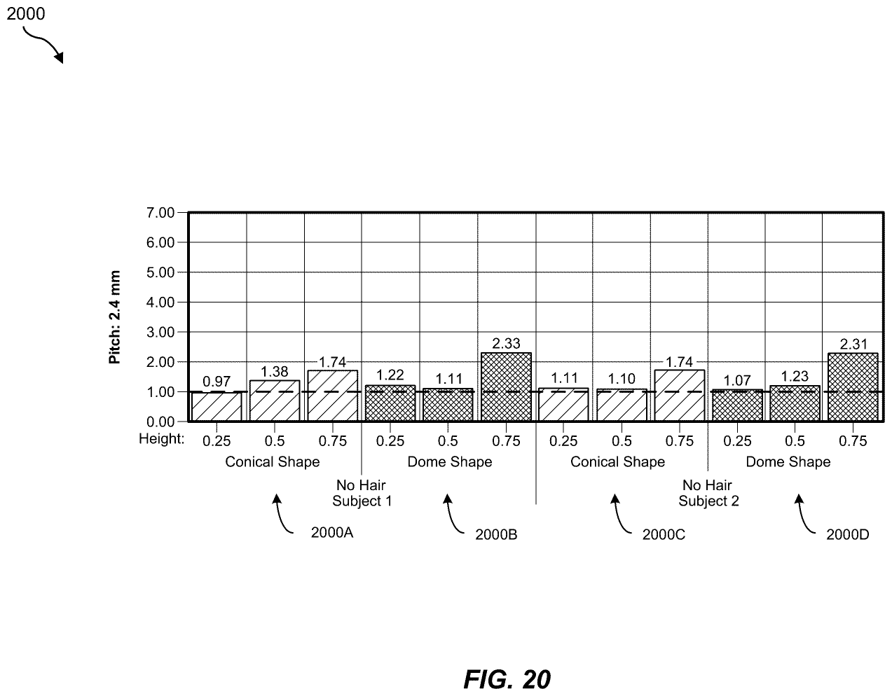

Referring to FIG. 20, effects 2000 of heights on impedance at 2.4 mm pitch for microstructures of electrodes for human-computer interaction are shown. For example, effects 2000A and 2000C demonstrate impedance experienced with different users with absence of hair and employing conical-shaped electrodes having heights ranging from 0.25 mm to 0.75 mm. Additionally, effects 2000B and 2000D demonstrate impedance experienced with the different users with absence of hair and employing dome-shaped electrodes having heights ranging from 0.25 mm to 0.75 mm.

Comparing FIG. 19 and FIG. 20, it can be appreciated that normalized impedance tends to increase with increase of microstructure height. Additionally, this trend is consistent on both conical and dome shaped microstructured electrodes (e.g., pitch=1.2 mm) on some users.

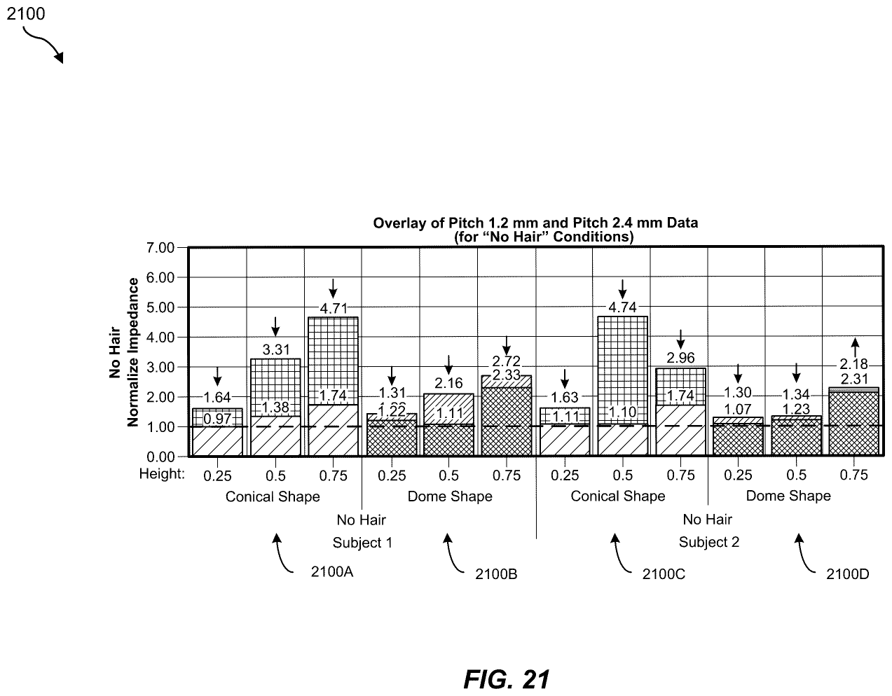

Referring to FIG. 21, an overlay 2100 of effects 1900 and 2000 is shown under the absence of hair. For example, effects 2100A and 2100C demonstrate impedance experienced with different users with absence of hair and employing conical-shaped electrodes having heights ranging from 0.25 mm to 0.75 mm. Additionally, effects 2100B and 2100D demonstrate impedance experienced with the different users with absence of hair and employing dome-shaped electrodes having heights ranging from 0.25 mm to 0.75 mm. In FIG. 21, labeled arrows demonstrate the direction of change in the normalized impedance when the pitch is increased from 1.2 mm to 2.4 mm for non-hairy skin.

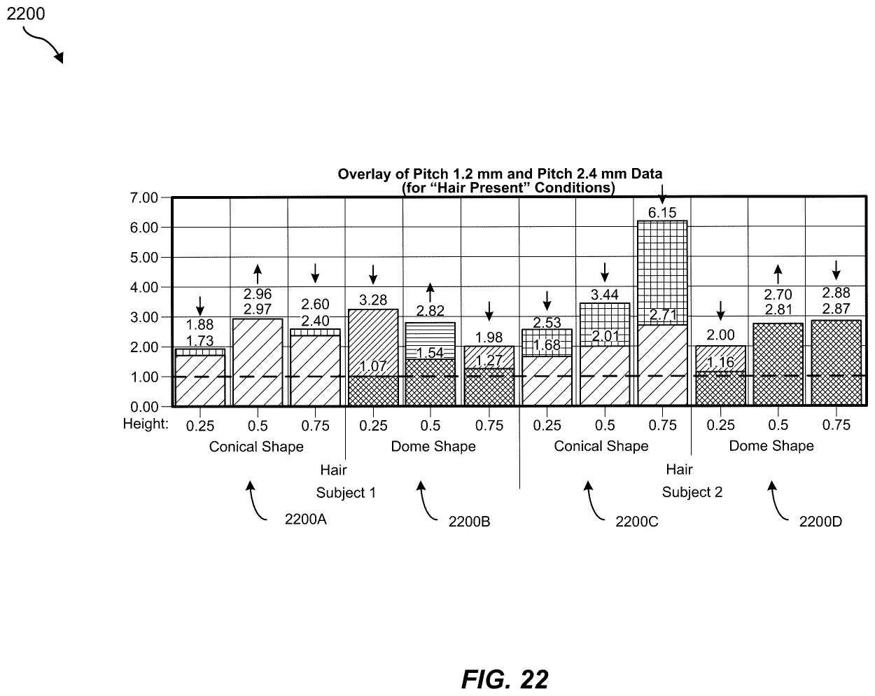

Referring to FIG. 22, another overlay 2200 demonstrates the impact to impedance with presence of hair. For example, effects 2200A and 2200C demonstrate impedance experienced with different users with presence of hair and employing conical-shaped electrodes having heights ranging from 0.25 mm to 0.75 mm. Additionally, effects 2200B and 2200D demonstrate impedance experienced with the different users with presence of hair and employing dome-shaped electrodes having heights ranging from 0.25 mm to 0.75 mm. In FIG. 22, labeled arrows demonstrate the direction of change in the normalized impedance when the pitch is increased from 1.2 mm to 2.4 mm for hairy skin.

Comparing FIG. 21 and FIG. 22, it can be appreciated that normalized impedance decreases with increased pitch of microstructures on the electrode surface (i.e., decreased microstructure density) when the test is performed on non-hairy skin. The same can generally be said for hairy skin, but the results vary to a greater degree than with non-hairy skin.

Referring to FIG. 23 exemplary hair coverage 2300 of a subject in a skin region for application of microelectrodes for human-computer interaction is shown. FIG. 24 shows exemplary hair coverage 2400 of another subject in a skin region for application of microelectrodes for human-computer interaction. For FIG. 23 and FIG. 24, raw images of test regions were processed for calculation of approximate percent hair coverage. For the subject of FIG. 23, hair coverage is approximately thirty-six percent. For the subject of FIG. 24, hair coverage is approximately nineteen percent.

Referring to FIG. 25, an overlay 2500 shows effects of hair density of subjects in skin regions for application of microelectrodes for human-computer interaction. For example, effects 2500A and 2500C demonstrate impedance experienced with different users employing conical-shaped electrodes having heights ranging from 0.25 mm to 0.75 mm. Additionally, effects 2500B and 2500D demonstrate impedance experienced with the different users employing dome-shaped electrodes having heights ranging from 0.25 mm to 0.75 mm. In FIG. 25, labeled arrows demonstrate the direction of change in the normalized impedance when the test is repeated on hairy skin after the test on bare skin (e.g., no hair) for 1.2 mm pitch microstructures.

Referring to FIG. 26, an overlay 2600 shows effects of hair density of subjects in skin regions for application of microelectrodes for human-computer interaction. For example, effects 2600A and 2600C demonstrate impedance experienced with different users employing conical-shaped electrodes having heights ranging from 0.25 mm to 0.75 mm. Additionally, effects 2600B and 2600D demonstrate impedance experienced with the different users employing dome-shaped electrodes having heights ranging from 0.25 mm to 0.75 mm. In FIG. 26, labeled arrows demonstrate the direction of change in the normalized impedance when the test is repeated on hairy skin after the test on bare skin (e.g., no hair) for 2.4 mm pitch microstructures.

Comparing FIG. 25 and FIG. 26, it can be appreciated that dense (pitch: 1.2 mm) and tall microstructured electrodes (height: 0.5 and 0.75 mm) are effective on a first subject with higher skin hair coverage (36%). However, a similar case was not observed for a second subject with less hair coverage (19%).

As set forth above, results from two subjects show that presence of microstructures on the surface of biopotential electrodes (e.g., non-penetrating the skin) has the potential of decreasing the skin-electrode impedance of subjects with significant skin hair coverage. In the study, micromachined metal electrodes with varying shape, pitch, and height of surface microstructures were used to measure skin-electrode impedance using a desktop impedance recording system. Results show that dense and tall microstructured electrodes may be effective in decreasing the skin-electrode impedance of a subject with at least 30% skin hair coverage. This improvement at the skin-electrode interface may be attributed to improved electrode penetration and increased electrode surface area in the presence of hair with respect to electrodes without surface microstructures.

The disclosed microstructured electrodes can be used in various ways. For example, microstructured biopotential recording electrodes with varying shapes, densities, and heights can be personalized based on the user needs. For example, during the mechanical design of a wristband, wrist skin hair coverage of the user can be measured from different angles using an imaging technique. Then, the specifications of microstructured electrodes and the locations of microstructured electrodes on the wristband can be determined based on the wrist areas with significant hair coverage, such as palmar, ulnar, or radial wrist sites. Additionally, with the disclosed miocrostructured electrodes, low skin-electrode impedance can be achieved in the presence of significant skin hair coverage (>30%) with respect to benchmarks (e.g., electrodes without surface microstructures). The disclosed microstructured electrodes may improve the effectiveness of EMG or impedance-based gesture detection systems due to its improved skin electrode coupling. Also, the disclosed microstructured electrodes can enables smooth wristband integration and improved user comfort. For example, the microstructured electrodes can be integrated in a manner that renders them flush with the surface of the wristband, which eliminates the need for protruding electrodes. Further, materials of the microstructured electrodes can be extended to include soft materials such as conductive polymers for improved user comfort, increased hair penetration, ease-of-fabrication, and cost effectiveness.

### Example Embodiments

In some embodiments, a computer-implemented method may include measuring from different angles, by at least one processor and using an imaging technique, skin hair coverage in a skin surface region of a user, determining, by the at least one processor and based on the measurements, specifications of biopotential electrodes including microstructures on a surface thereof configured to contact the skin surface region of the user and locations of the biopotential electrodes on a wearable device, and performing human-computer interaction, by at least one processor, based on biopotential measurements provided by the biopotential electrodes that include microstructures on the surface thereof that are configured to contact the skin surface region of the user.

In one embodiment, a system may include at least one physical processor, and a computer readable medium having instructions recorded thereon that, when executed by the at least one physical processor, cause the at least one physical processor to measure from different angles, using an imaging technique, skin hair coverage in a skin surface region of a user, determine, based on the measurements, specifications of biopotential electrodes including microstructures on a surface thereof configured to contact the skin surface region of the user and locations of the biopotential electrodes on a wearable device, and perform human-computer interaction based on biopotential measurements provided by the biopotential electrodes that include microstructures on the surface thereof that are configured to contact the skin surface region of the user.

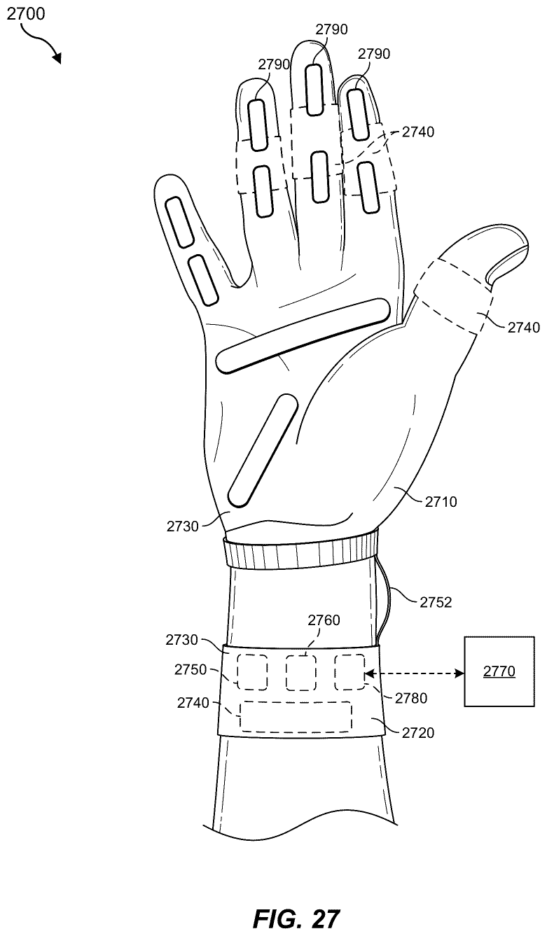

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 27 illustrates a vibrotactile system 2700 in the form of a wearable glove (haptic device 2710) and wristband (haptic device 2720). Haptic device 2710 and haptic device 2720 are shown as examples of wearable devices that include a flexible, wearable textile material 2730 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 2740 may be positioned at least partially within one or more corresponding pockets formed in textile material 2730 of vibrotactile system 2700. Vibrotactile devices 2740 may be positioned in locations to provide a vibrating sensation (e.g., haptic feedback) to a user of vibrotactile system 2700. For example, vibrotactile devices 2740 may be positioned against the user's finger(s), thumb, or wrist, as shown in FIG. 27. Vibrotactile devices 2740 may, in some examples, be sufficiently flexible to conform to or bend with the user's corresponding body part(s).

A power source 2750 (e.g., a battery) for applying a voltage to the vibrotactile devices 2740 for activation thereof may be electrically coupled to vibrotactile devices 2740, such as via conductive wiring 2752. In some examples, each of vibrotactile devices 2740 may be independently electrically coupled to power source 2750 for individual activation. In some embodiments, a processor 2760 may be operatively coupled to power source 2750 and configured (e.g., programmed) to control activation of vibrotactile devices 2740.

Vibrotactile system 2700 may be implemented in a variety of ways. In some examples, vibrotactile system 2700 may be a standalone system with integral subsystems and components for operation independent of other devices and systems. As another example, vibrotactile system 2700 may be configured for interaction with another device or system 2770. For example, vibrotactile system 2700 may, in some examples, include a communications interface 2780 for receiving and/or sending signals to the other device or system 2770. The other device or system 2770 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 2780 may enable communications between vibrotactile system 2700 and the other device or system 2770 via a wireless (e.g., Wi-Fi, BLUETOOTH, cellular, radio, etc.) link or a wired link. If present, communications interface 2780 may be in communication with processor 2760, such as to provide a signal to processor 2760 to activate or deactivate one or more of the vibrotactile devices 2740.

Vibrotactile system 2700 may optionally include other subsystems and components, such as touch-sensitive pads 2790, pressure sensors, motion sensors, position sensors, lighting elements, and/or user interface elements (e.g., an on/off button, a vibration control element, etc.). During use, vibrotactile devices 2740 may be configured to be activated for a variety of different reasons, such as in response to the user's interaction with user interface elements, a signal from the motion or position sensors, a signal from the touch-sensitive pads 2790, a signal from the pressure sensors, a signal from the other device or system 2770, etc.

Although power source 2750, processor 2760, and communications interface 2780 are illustrated in FIG. 27 as being positioned in haptic device 2720, the present disclosure is not so limited. For example, one or more of power source 2750, processor 2760, or communications interface 2780 may be positioned within haptic device 2710 or within another wearable textile.

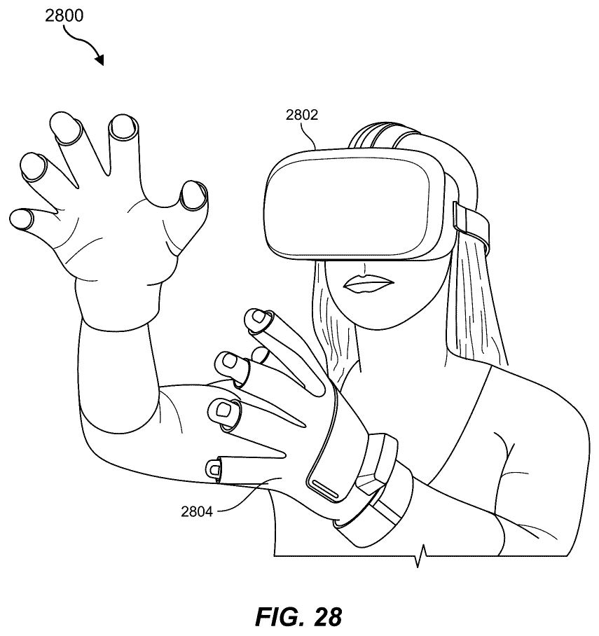

Haptic wearables, such as those shown in and described in connection with FIG. 27, may be implemented in a variety of types of artificial-reality systems and environments. FIG. 28 shows an example artificial-reality environment 2800 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 2802 generally represents any type or form of virtual-reality system, such as virtual-reality system 2800 in FIG. 28. Haptic device 2804 generally represents any type or form of wearable device, worn by a user of an artificial-reality system, that provides haptic feedback to the user to give the user the perception that he or she is physically engaging with a virtual object. In some embodiments, haptic device 2804 may provide haptic feedback by applying vibration, motion, and/or force to the user. For example, haptic device 2804 may limit or augment a user's movement. To give a specific example, haptic device 2804 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 2804 to send action requests to a console. Examples of action requests include, without limitation, requests to start an application and/or end the application and/or requests to perform a particular action within the application.

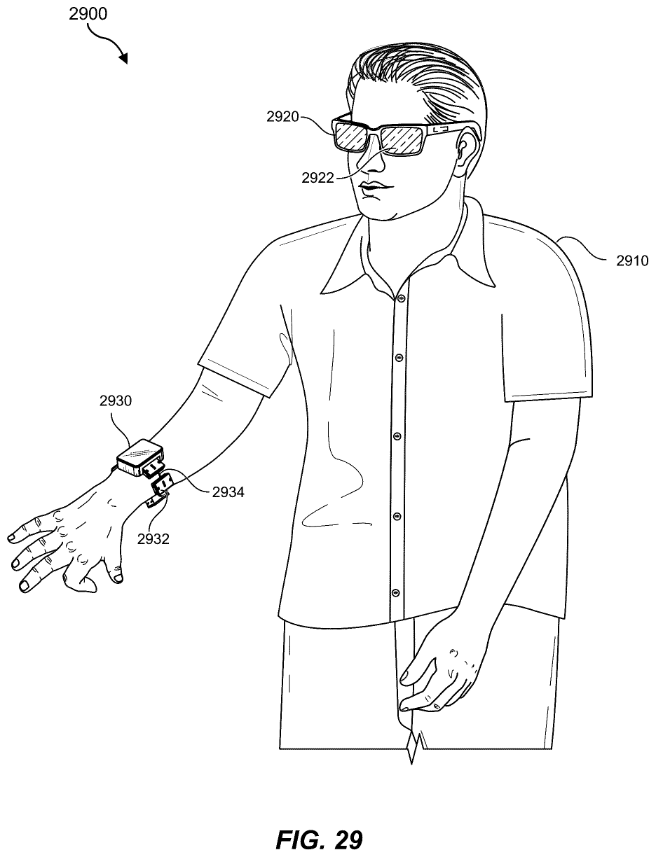

While haptic interfaces may be used with virtual-reality systems, as shown in FIG. 28, haptic interfaces may also be used with augmented-reality systems, as shown in FIG. 29. FIG. 29 is a perspective view of a user 2910 interacting with an augmented-reality system 2900. In this example, user 2910 may wear a pair of augmented-reality glasses 2920 that may have one or more displays 2922 and that are paired with a haptic device 2930. In this example, haptic device 2930 may be a wristband that includes a plurality of band elements 2932 and a tensioning mechanism 2934 that connects band elements 2932 to one another.

One or more of band elements 2932 may include any type or form of actuator suitable for providing haptic feedback. For example, one or more of band elements 2932 may be configured to provide one or more of various types of cutaneous feedback, including vibration, force, traction, texture, and/or temperature. To provide such feedback, band elements 2932 may include one or more of various types of actuators. In one example, each of band elements 2932 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 2710, 2720, 2804, and 2930 may include any suitable number and/or type of haptic transducer, sensor, and/or feedback mechanism. For example, haptic devices 2710, 2720, 2804, and 2930 may include one or more mechanical transducers, piezoelectric transducers, and/or fluidic transducers. Haptic devices 2710, 2720, 2804, and 2930 may also include various combinations of different types and forms of transducers that work together or independently to enhance a user's artificial-reality experience. In one example, each of band elements 2932 of haptic device 2930 may include a vibrotactor (e.g., a vibrotactile actuator) configured to vibrate in unison or independently to provide one or more of various types of haptic sensations to a user.

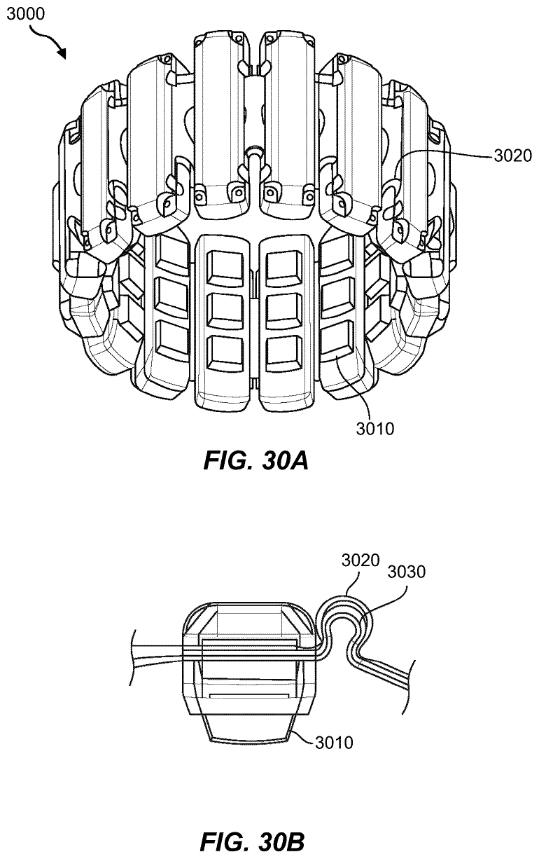

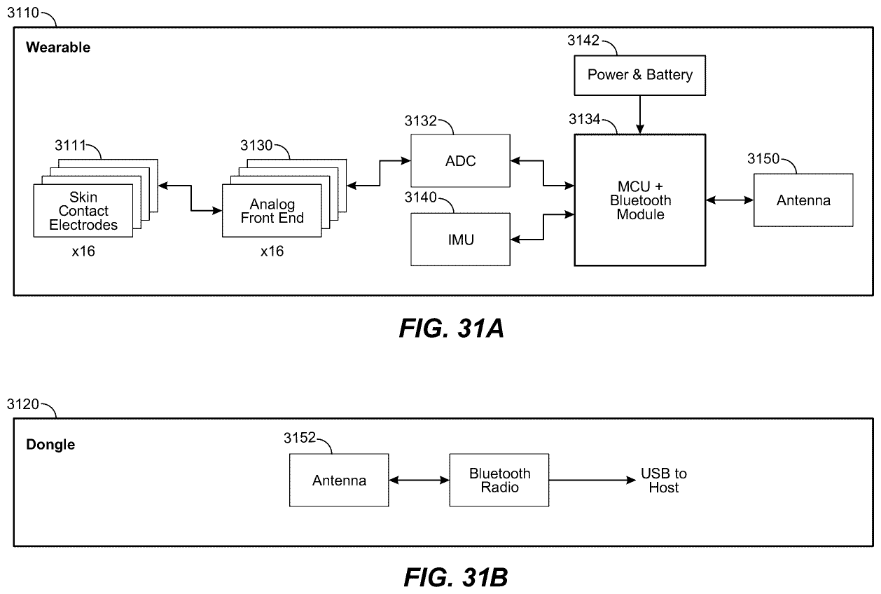

FIG. 30A illustrates an exemplary human-machine interface (also referred to herein as an EMG control interface) configured to be worn around a user's lower arm or wrist as a wearable system 3000. In this example, wearable system 3000 may include sixteen neuromuscular sensors 3010 (e.g., EMG sensors) arranged circumferentially around an elastic band 3020 with an interior surface 3030 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 30B illustrates a cross-sectional view through one of the sensors of the wearable device shown in FIG. 30A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 3210 is discussed in more detail below with reference to FIGS. 31A and 31B.

FIGS. 31A and 31B illustrate an exemplary schematic diagram with internal components of a wearable system with EMG sensors. As shown, the wearable system may include a wearable portion 3110 (FIG. 31A) and a dongle portion 3120 (FIG. 31B) in communication with the wearable portion 3110 (e.g., via BLUETOOTH or another suitable wireless communication technology). As shown in FIG. 31A, the wearable portion 3110 may include skin contact electrodes 3311, examples of which are described in connection with FIGS. 30A and 30B. The output of the skin contact electrodes 3111 may be provided to analog front end 3130, which may be configured to perform analog processing (e.g., amplification, noise reduction, filtering, etc.) on the recorded signals. The processed analog signals may then be provided to analog-to-digital converter 3132, which may convert the analog signals to digital signals that can be processed by one or more computer processors. An example of a computer processor that may be used in accordance with some embodiments is microcontroller (MCU) 3134, illustrated in FIG. 31A. As shown, MCU 3134 may also include inputs from other sensors (e.g., IMU sensor 3140), and power and battery module 3142. The output of the processing performed by MCU 3134 may be provided to antenna 3150 for transmission to dongle portion 3120 shown in FIG. 31B.

Dongle portion 3120 may include antenna 3152, which may be configured to communicate with antenna 3350 included as part of wearable portion 3110. Communication between antennas 3150 and 3152 may occur using any suitable wireless technology and protocol, non-limiting examples of which include radiofrequency signaling and BLUETOOTH. As shown, the signals received by antenna 3152 of dongle portion 3120 may be provided to a host computer for further processing, display, and/or for effecting control of a particular physical or virtual object or objects.

Although the examples provided with reference to FIGS. 30A-30B and FIGS. 31A-31B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive biopotential measurements to be transformed, transform the biopotential measurements, output a result of the transformation to perform human-computer interaction, use the result of the transformation to perform human-computer interaction, and store the result of the transformation to perform human-computer interaction. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure. Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

### Systems and Methods for Identifying and Mitigating Escalating Behavior in Public Messaging Forums

Social networking systems provide many ways for users to engage with each other. For example, social networking systems enable users to create content, share content, comment on each other's shared content, and to compose and send digital messages to each other. In some implementations, social networking systems also provide forums where groups of users may submit electronic messages to a group of social networking system users. These messages may be seen by any member of the group. In some implementations, the forum may also be public such that any social networking system user may view the messaging content within the forum.

While these public messaging forums enable discourse between a larger number of users, they also can give rise to an increase in adversarial behavior. For example, users can add messages to public messaging forums within a social networking system that include adversarial behavior such as hate speech, bullying, explicit language, and so forth.

In light of this, the present disclosure is generally directed to systems and methods for identifying and mitigating escalating behavior in public messaging forums. As will be explained in greater detail below, embodiments of the present disclosure may seed low confidence phrases and keywords in a repository and compare public messages against the low confidence phrases and keywords. The systems and methods may further send any matching messages for human review. If the human review determines that an identified message includes adversarial behavior, the systems and methods described herein may mitigate this behavior by removing the message from the forum and/or by censuring the message sender. Overtime, the systems and methods described herein may upgrade low confidence keywords and phrases that are consistently determined to be adversarial to high confidence keywords and phrases. The systems and methods described herein may automatically mitigate future messages that correspond to high confidence keywords and phrases without any human intervention.

Features from any of the embodiments described herein may be used in combination with one another in accordance with the general principles described herein. These and other embodiments, features, and advantages will be more fully understood upon reading the following detailed description in conjunction with the accompanying claim.

As mentioned above, escalation handling may be a critical integrity capability needed to respond to unanticipated increases in adversarial behavior and to mitigate harm swiftly and effectively. As popularity and engagement increases in connection with new public messaging platforms, this capability becomes even more critical especially as building mature machine learning models take time. For example, sophisticated machine learning models need ample data to learn patterns from and to make predictions with high precision. Public message forums and other messaging platforms that are not subject to end-to-end encryption may not have had the ability to automatically identify and mitigate adversarial behavior.

As such, an escalation handling system is described herein that leverages keyword and phrase matching. In some implementations, the escalation handling system may focus mainly on text as text is the primary modality in most public messaging forums. In other implementations, the escalation handling system may include features that focus on images, video, audio, and other means of communication.

In at least one implementation, the escalation handling system can seed a repository (e.g., a text bank) with low confidence keywords and phrases. In one or more implementations, low confidence keywords and phrases can include language that potentially intends harm but without enough certainty to directly cause mitigation. In at least one implementation, the escalation handling system can scan newly created public messages (e.g., associated with a particular group or forum) to determine if the content of the messages is similar to any of the low confidence keywords or phrases in the repository. For example, the escalation handling system can utilize string comparison, or machine learning techniques to determine similarity. In response to determining that a message is similar to a low confidence keyword or phrase, the escalation handling system can send that message to a human reviewer.

In one or more implementations, the human review may assess the message to determine whether the message includes or indicates adversarial behavior. In some implementations, the escalation handling system can filter the number of messages sent for human review when human review capacity is constrained. For example, the escalation handling system can filter the messages based on virality. To illustrate, the escalation handling system may send a message for human review when the message is similar to a low confidence keyword or phrase and the message has been read a number of time that surpasses a predetermined threshold (e.g., the message has been read by more than 100 forum members or by more than 100 times). The escalation handling system can determine virality based on messaging activity surrounding a particular message (e.g., shares, responses, reads).

In response to a human reviewer assessing a message and determining that the message includes adversarial behavior, the escalation handling system can take steps to mitigate the message. For example, the escalation handling system can remove the message from the messaging forum. In additional or alternative implementations, the escalation handling system can also take mitigation steps in connection with the message sender. For example, the escalation handling system can enter a strike against the message sender and maintain a record of that strike. In response to determining that the message sender has more than a threshold number of strikes, the escalation handling system may take further steps against the message sender such as removing the message sender from the forum, removing messaging privileges from the message sender, and so forth.

Over time, the escalation handling system may determine that certain low confidence keywords and/or phrases have a probability of leading to mitigating steps upon human review. In response to this determination, the escalation handling system can move these low confidence keywords and/or phrases to a high confidence repository (e.g., text bank). At this point, the escalation handling system may automatically scan newly created public messages within the forum for content similar to keywords and phrases in the high confidence repository. In response to determining that a message is similar to a keyword or phrase in the high confidence repository, the escalation handling system may automatically take mitigation steps in connection with that message—without any human intervention. As such, the escalation handling system may remove the message, and/or enter strikes against the message sender. In some implementations, the escalation handling system may automatically take additional mitigating steps against the message sender if the number of strikes against the sender exceeds a predetermined threshold.

In some implementations, in response to moving a low confidence keyword or phrase to the high confidence repository, the escalation handling system may retroactively identify messages previously entered into the forum for additional mitigation. For example, the escalation handling system may identify messages added to the messaging forum within a previous threshold amount of time (e.g., a week, a month) that are similar to keywords and phrases in the high confidence repository. The escalation handling system may then automatically take mitigation steps in connection with those identified messages as described above.

The escalation handling system may periodically seed the low confidence repository with keywords and phrases in connection with various types of harm. In this way, the escalation handling system can tailor itself to current and up-to-date harmful language. In this way, the escalation handling system efficiently and effectively utilizes a hybrid approach to identify and mitigate messages that include harmful language and behavior.

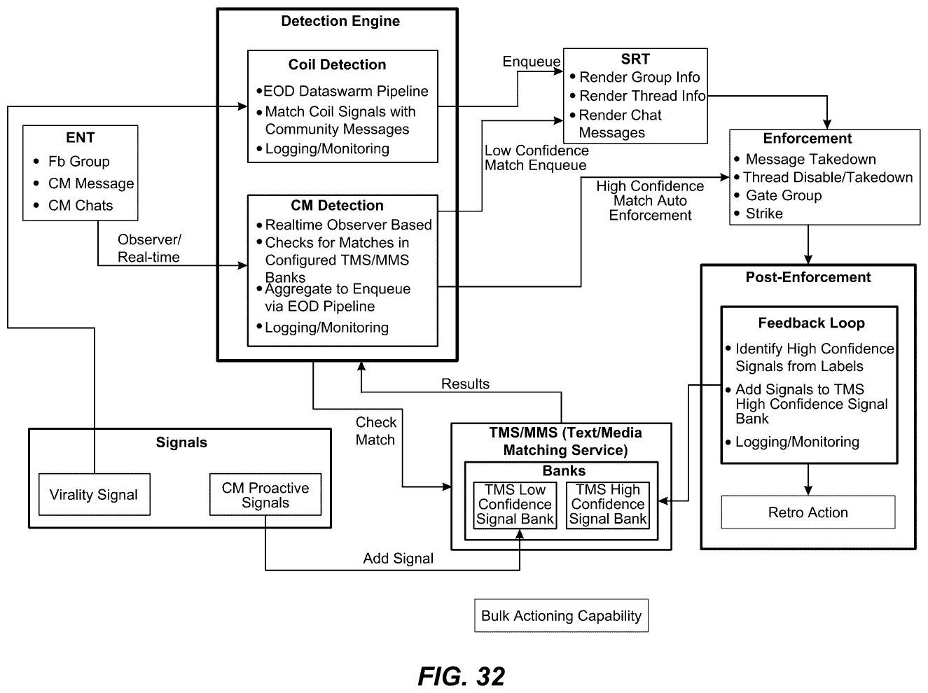

FIG. 32 illustrates an overview of the escalation handling system in connection with a ground messaging platform. For example, a detection engine within the escalation handling system can receive or observe group messages as well as various signals associated with those messages in real-time. To illustrate, the detection engine can receive message text, as well as virality signals (e.g., filtered by civic groups or by community) and proactive signals (e.g., keyword-based signals). Virality can be based on, for example, thread joins, message sends, and message reads. In one or more implementations, messages can be enqueued for analysis based on the virality signals. For example, based on review capacity associated with the escalation handling system, the top N viral groups, threads, and/or messages can be enqueued for review.

The detection engine can further check for matches of the groups, threads, and/or messages against the low confidence signal bank (e.g., the low confidence repository) and the high confidence signal bank (e.g., the high confidence repository). In response to determining that a match exists with the low confidence signal bank, the detection engine can enqueue the group, thread, and/or message for human review. In response to determining that a match exists with the high confidence signal bank, the detection engine can automatically enforce one or more actions against the group, thread, and/or message.

When enforcement is needed, the escalation handling system can add strikes against a user or group. These strikes may accumulate based on the violation type. In response to the number of strikes exceeding a threshold amount, the escalation handling system can take down messages, disable or take down threads, and/or gate groups. Moreover, the escalation handling system can engage in bulk actioning based on message ids. For example, the escalation handling system can retroactively analyze and potentially enforce against messages that were added to the platform in the past (e.g., within a threshold amount of time). Conversely, the escalation handling system can also retroactively undo a previous enforcement against a message, thread, or group based on additional analysis. Additionally, in some implementations, the escalation handling system can generate and show a visual indicator (e.g., a banner, popup, label) to give additional context to users once one or more enforcement actions have been taken.

Following enforcement, the escalation handling system can identify high confidence signals and add those signals to the high confidence signal banks. The escalation handling system can further log and monitor based on the previous enforcement. Moreover, in some implementations, the escalation handling system can use the high confidence signal bank to predict additional violating keywords. The escalation handling system can add or remove keywords from the high confidence signal bank based on these predictions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

### Systems and Methods of Tensor-Based Cluster Matching for Optics System Color Matching

The traditional method of performing image color calibration for cameras has the limitation of accuracy drift over different luminance levels. The color correction accuracy can be negatively affected by an imaging system's vignette effect, the non-linear sensor response to camera exposure time setting, and the device under test's off-axis effect.

The present disclosure is generally directed to tensor-based cluster matching for optics system color matching. As will be explained in greater detail below, embodiments of the present disclosure may integrate additional variables into a 5-dimension tensor-based procedure with a geometric, exposure time look-up-table and a conjugate of a camera vignette factor.

Features from any of the embodiments described herein may be used in combination with one another in accordance with the general principles described herein. These and other embodiments, features, and advantages will be more fully understood upon reading the following detailed description in conjunction with the accompanying drawings and claims.

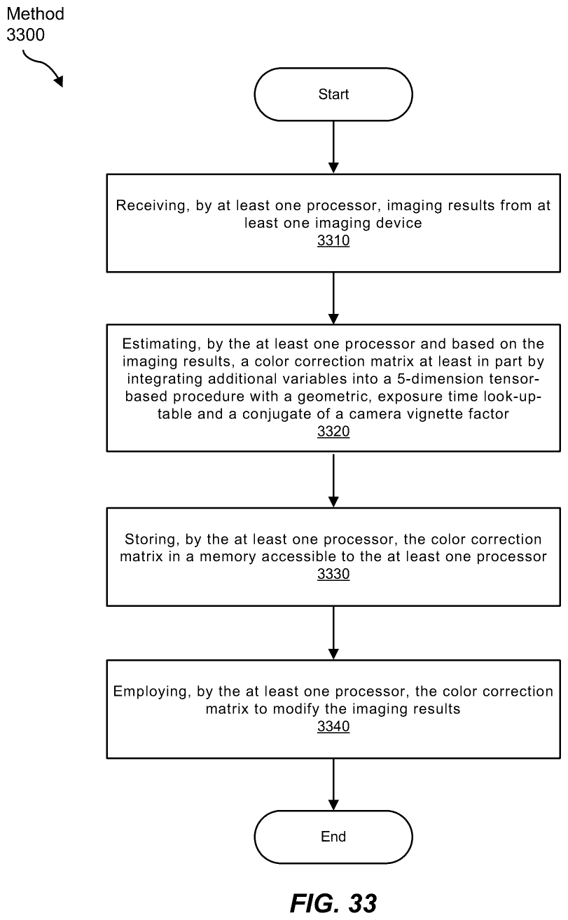

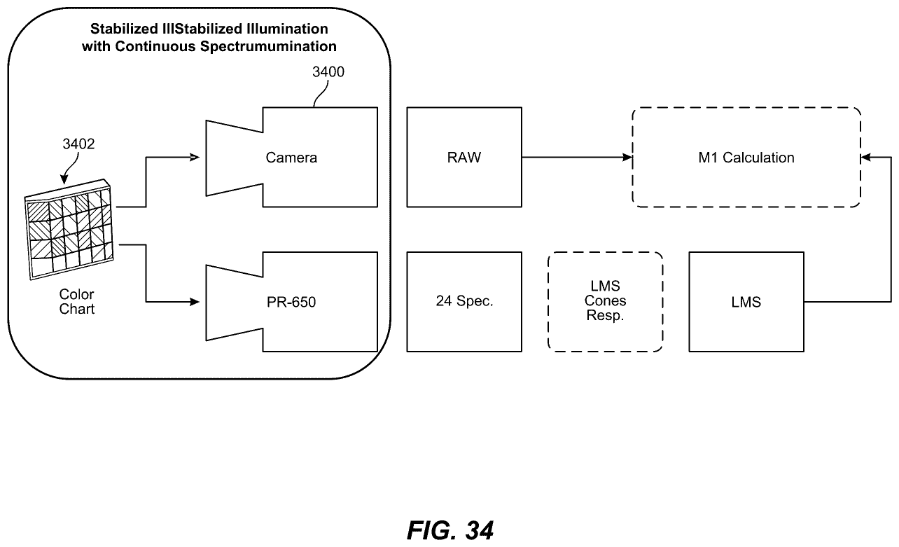

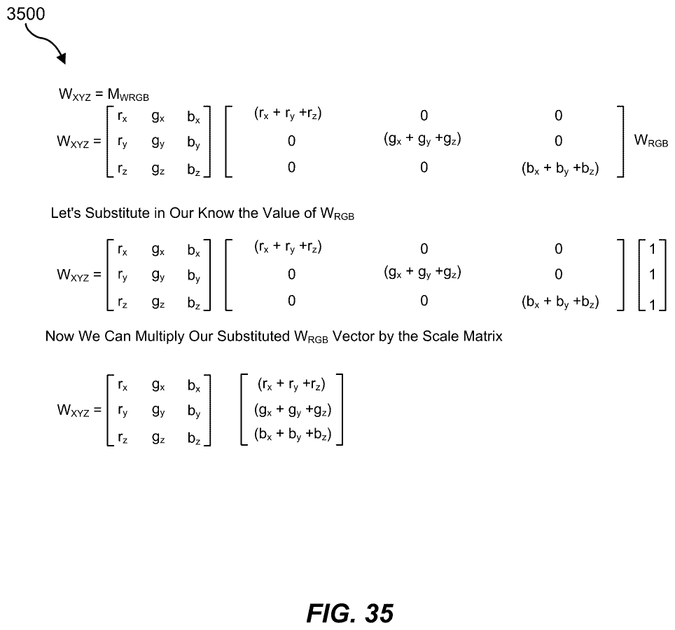

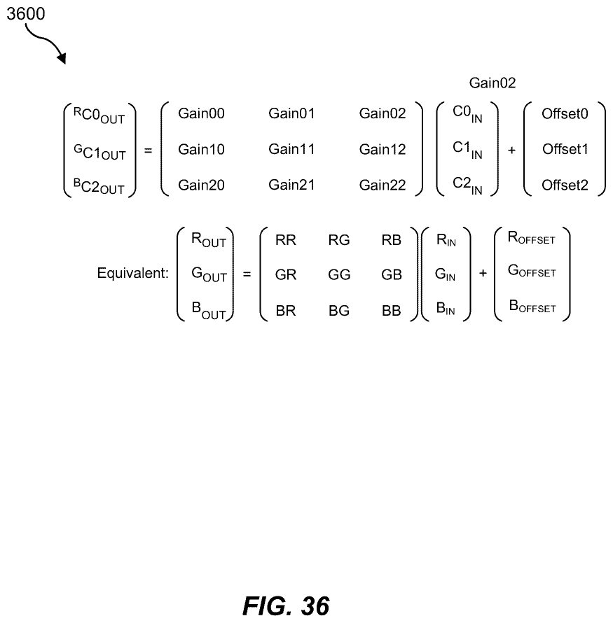

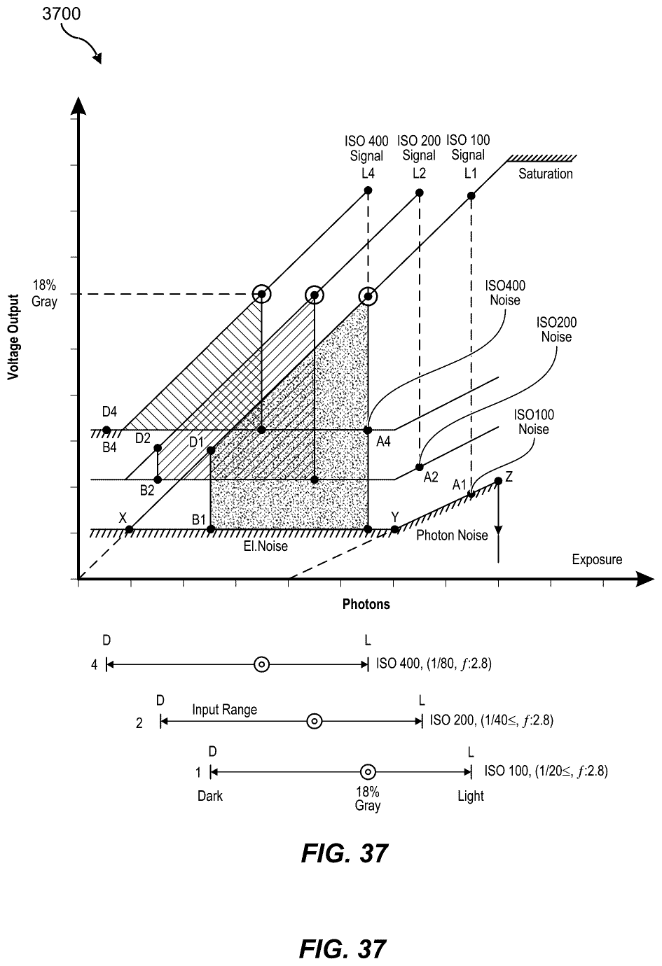

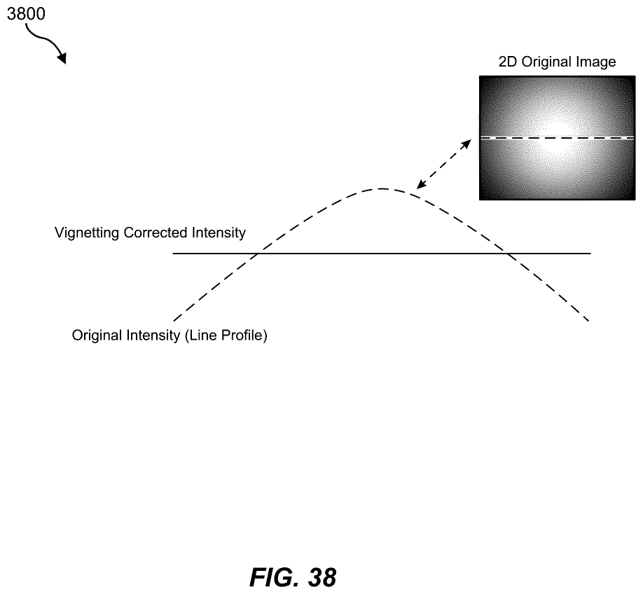

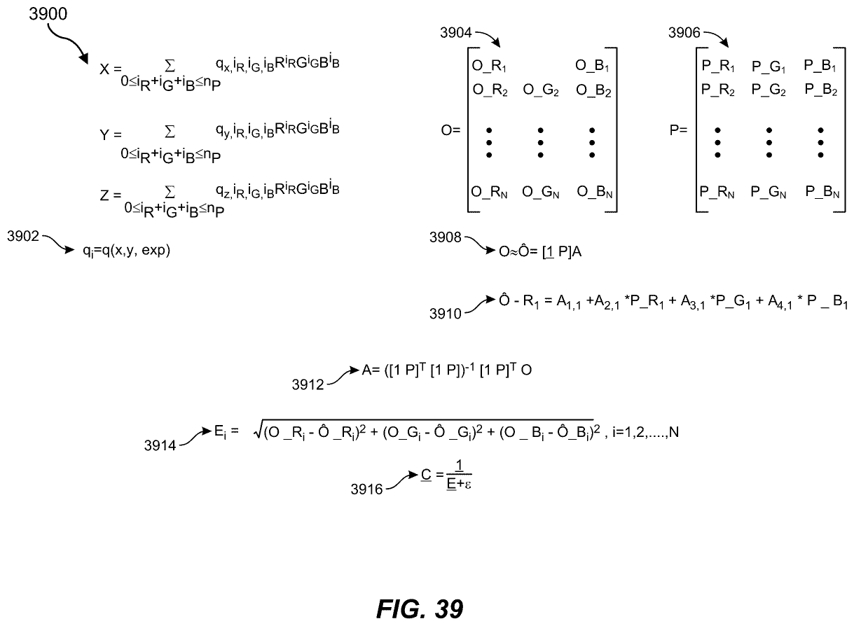

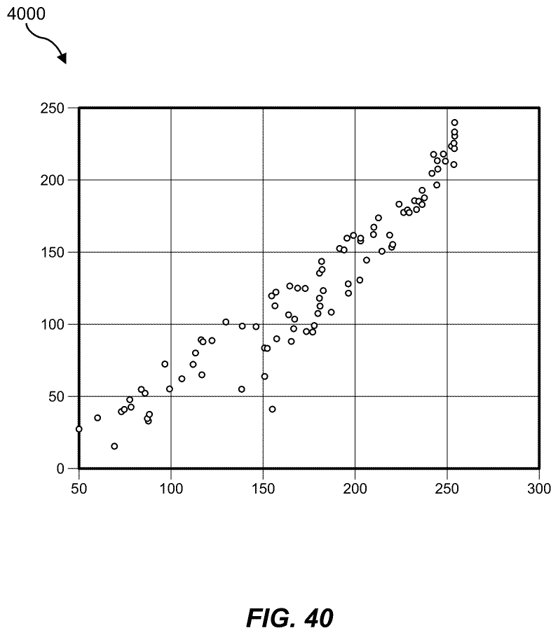

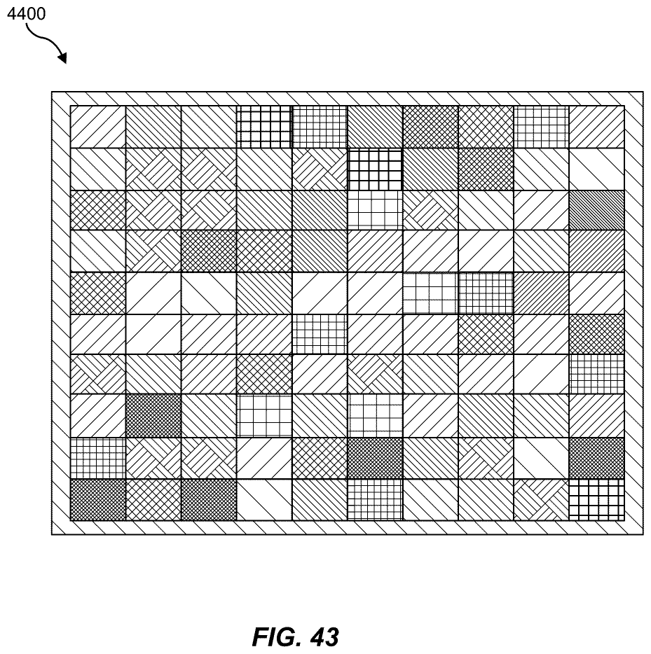

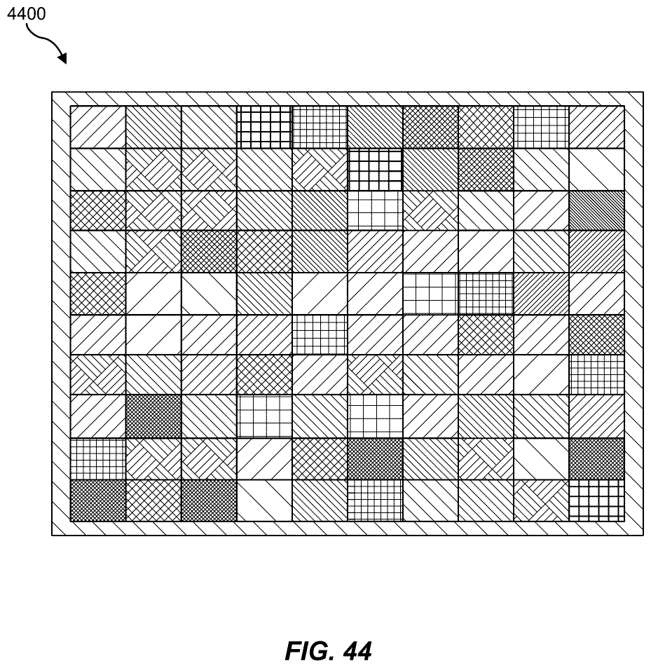

The following will provide, with reference to FIGS. 33-43, detailed descriptions of systems and methods of tensor-based cluster matching for optics system color matching. For example, a method of tensor-based cluster matching for optics system color matching will be described with reference to FIG. 33. Additionally, an example of image calibration will be described with reference to FIG. 34, and example color correction matrices will be described with reference to FIGS. 35 and 36. Also, sensor exposure time versus stimulus illumination intensity and vignette effect of an overall imaging system will be described with to reference to FIGS. 37 and 38. Further, procedures relating to color correction matrix estimation will be described with reference to FIG. 39. Further, an iterative tuning procedure and comparative results will be described with reference to FIGS. 40-44.

FIG. 33 is a flow diagram of an exemplary computer-implemented method 3300 of tensor-based cluster matching for optics system color matching. The steps shown in FIG. 33 may be performed by any suitable computer-executable code and/or computing system, including the system(s) illustrated in FIG. 34. In one example, each of the steps shown in FIG. 33 may represent an algorithm whose structure includes and/or is represented by multiple sub-steps, examples of which will be provided in greater detail below.

As illustrated in FIG. 33, at step 3310 one or more of the systems described herein may receive imaging results. For example, at least one processor may receive imaging results from at least one imaging device.

At step 3320, one or more of the systems described herein may estimate a color correction matrix. For example, at least one processor may estimate, based on the imaging results, a color correction matrix at least in part by integrating additional variables into a 5-dimension tensor-based procedure with a geometric, exposure time look-up-table and a conjugate of a camera vignette factor.

At step 3330, one or more of the systems described herein may store the color correction matrix. For example, at least one processor may store the color correction matrix in a memory accessible to the at least one processor.

At step 3340, one or more of the systems described herein may modify the imaging results. For example, at least one processor may employ the color correction matrix to modify the imaging results.

FIG. 34 illustrates an example of image calibration. The calibration of a camera 3400 to an image colorimeter 3402 can typically engage with one standard illuminant measured by two or more instruments (e.g., a reference camera PR650 and/or the camera 3400 to be calibrated). The output of both the reference instrument (e.g., reference camera PR650) and the to-be-calibrated camera 3400 can return as a color correction matrix, which can be represented by formula 3500 in FIG. 35.

Referring to FIGS. 37 and 38, more complicated matrices can also be derived by considering the interactions between non-orthogonal primary color channels (e.g., sensor exposure time 3700 versus stimulus illumination intensity and vignette effect 3800 of the overall system). Turning to FIG. 39, various procedures 3900-3916 relate to color correction matrix estimation. For example, to compensate both sensor exposure time and the vignette effect, the element of color correction matrix can be reconstructed as procedure 3900, where q is the coefficient of location of x, y and exposure time, and qᵢ can be determined according to procedure 3902. To provide more generosity of different gray levels, restricting the model application range to the overall color volume can be avoided. Instead, a local matrix O can have N color samples in different R G B channels as in procedure 3904. Then, the processed image P can also have N color samples that correspond to those in the original image as in procedure 3906.

What is sought is the optimal linear transformation matrix A (e.g., 4 rows×3 columns) that best maps the processed color samples P into the corresponding original color samples O as in procedure 3908, where 1 is a column vector of N ones that provides a DC offset, or shift, in the brightness level. Thus, each transformed pixel color is a linear combination of a DC offset and the processed red, green, and blue samples. For example, the red color of the first transformed pixel can be determined according to procedure 3910, where the two subscripts on the A matrix elements denote their row and column positions, respectively. Given more than twelve independent RGB samples (e.g., the number of unknowns in the A matrix), then the set of linear equations can be over-determined and the least-squares solution can be given by procedure 3914, which can be a fundamental equation used to estimate the A color correction matrix.

The processed image normally contains spatial distortions as well as color calibration problems. In addition, the processed image may not be properly registered, or aligned, to the original image. These problems can create outliers (e.g., processed color samples that do not agree with the majority fit) that may unduly influence the estimation of the color correction matrix A. Utilizing an iterative least-squares solution with a cost function can help minimize the weight of outliers in the fit. This robust least-squares solution reduces the weight of outliers in the fit using a cost function that is inversely proportional to the error, or Euclidean distance, between the original sample O and the fitted processed sample O. If this error distance is large, then the associated cost of the fitting error will be small and the outlier's influence on the estimate will be minimal. To implement the robust least-squares solution, procedure 3914 can be applied to the N matching original and processed RGB color samples. Procedure 3914 utilizes the Euclidean distance as the optimization function with a tunable parameter corresponding to exposure time and conjugate of the vignette factor. In the meantime, a cost vector (C) can be generated according to procedure 3916, and this cost vector can be an element-by-element reciprocal of the error vector (E) plus a small epsilon (E) utilized to cycle the outliner of extremely over-exposed signal and dark current noise which does not add value to the merit.

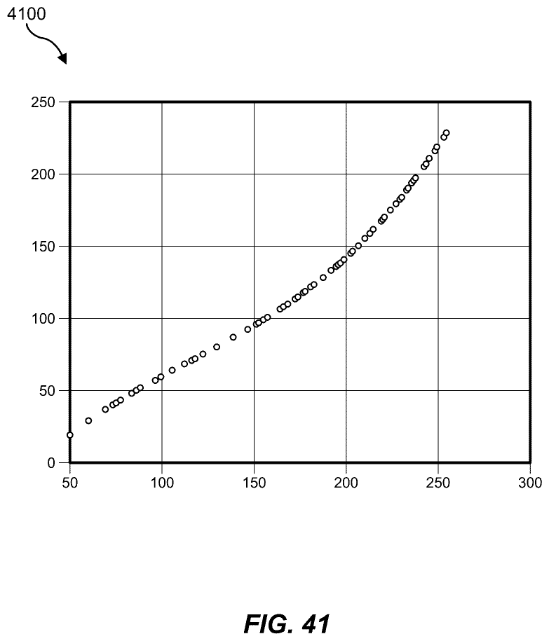

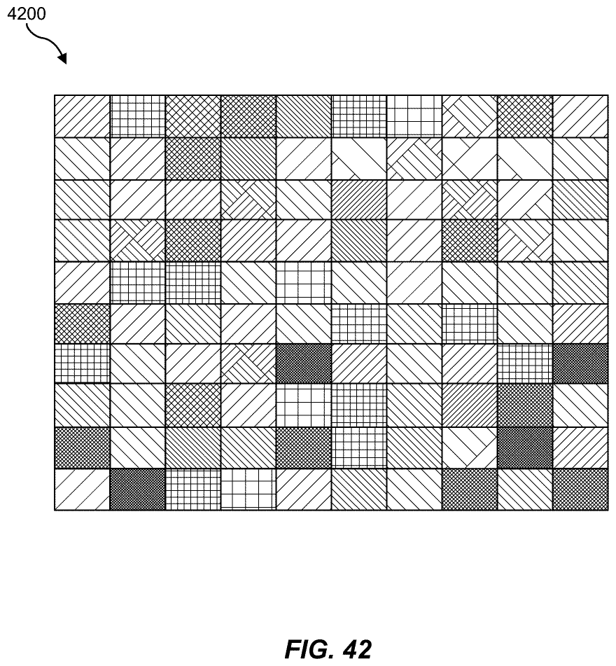

Through continuous optimization, this robust least-squares solution can yield a very linear channel of processed signals of both O and P. FIGS. 40 and 41 respectively show a first iteration 4000 and a twentieth iteration 4100 of such a procedure performing iterative tuning of exposure time and conjugate of a vignette factor. Results of the application of such a procedure are shown in FIGS. 42-44, in which FIG. 42 shows a spectrometer reference patch 4200, a processed patch 4300 with fixed exposure time and vignette factor, and processed optimizations 4400 with exposure time and vignette factor being considered.

As set forth above, systems and methods of tensor-based cluster matching for optics system color matching are disclosed. For example, additional variables can be integrated into a 5-dimension tensor-based procedure with a geometric, exposure time look-up-table and a conjugate of a camera vignette factor.

### Transparent Circular Polarized Antenna on Lens

The present disclosure describes an antenna system designed for mobile electronic devices. In one embodiment, a transparent uniplanar right hand circular polarized (RHCP) antenna may be provided with antenna feeding mechanisms for global positioning system (GPS) L1 band (1575.42 MHz-1609.31 MHz) communication. In another embodiment, a uniplanar antenna radiating structure constructed from a transparent conductive material (e.g., transparent metal mesh) may be provided. The transparent metal mesh may be divided into active and dummy/floating segments through a process referred to as “precise incision.” A denser, active metal mesh segment may be applied around the perimeter of the transparent metal mesh. The contours of the metal mesh segments may be designed such that the majority of the surface currents at each side are perpendicular to the other sides. In some cases, the antenna may be excited by another active metal mesh segment that is connected to a coplanar waveguide (CPW) feed and is capacitively fed by the metal mesh segment.

In some cases, optically transparent conductors in the form of transparent metal mesh may allow visible light to pass through while simultaneously enabling conduction along the radio frequency (RF) spectrum. The implementations herein may have substantially lower sheet resistivity compared to other transparent conductors such as indium tin oxide (ITO) or Aluminum zinc oxide (AZO). This renders transparent metal mesh as a more suitable candidate for use as a conductor in high frequency RF applications.

Additionally, the utilization of transparent metal mesh in the design of antennas may provide a greater degree of design freedom, as it enables the physical configuration of the antenna to be concealed in different active and dummy sections of the transparent metal mesh. These benefits of using transparent metal mesh may enable many different antenna designs on a given substrate such as the lenses of a pair of augmented reality (AR) glasses. At least in some cases, the lenses are the single largest component within the glasses' form factor. As such, the use of transparent metal mesh may release fairly large portions of space within the AR glasses that was previously occupied by conventional laser direct sintering (LDS) antennas, flex antennas, or printed circuit board (PCB) antennas. The embodiments herein may utilize the added flexibility provided by the transparent metal mesh to design an optically transparent antenna while maintaining good antenna radiation efficiency. Furthermore, to minimize the complexity of integrating transparent metal mesh onto a lens through lamination, a uniplanar antenna with simple feeding may be provided.

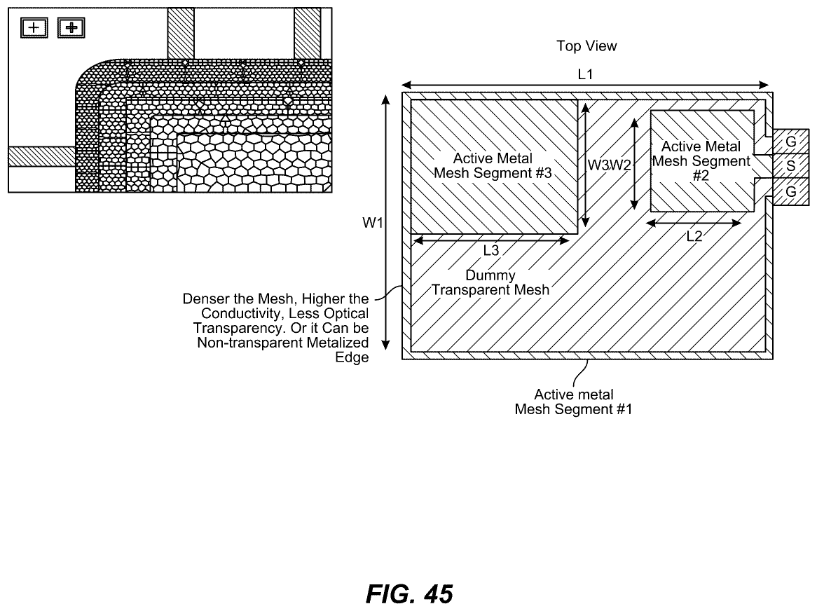

FIG. 45 illustrates a transparent uniplanar right hand circular polarized (RHCP) antenna with a relatively simple feeding mechanism. In some cases, as noted above, the RHCP antenna may be used for GPS L1 band (1575.42 MHz-1609.31 MHz) communication. FIG. 45 illustrates a uniplanar antenna radiating structure constructed from transparent metal mesh. The metal mesh may be divided into active (conducting) and dummy (non-conducting or floating) segments by precisely removing portions of conducting mesh and replacing them with non-conducting mesh. In some cases, denser active metal mesh segment #1 may be applied around the perimeter of the transparent metal mesh. The contours of metal mesh segment #1 may be designed such that most of the surface currents at its right and left sides are perpendicular to the top and bottom sides. The denser the mesh that is used, the higher the conductivity and the less optical transparency. In other cases, a wired, non-transparent metalized edge may be used. By altering the dimensions of the active metal mesh segment #3, L3, and W3, the circular-polarized band may be adjusted while keeping the other antenna parameters constant.

In some cases, the RHCP antenna may be excited by the active metal mesh segment #2 which is connected to a coplanar waveguide (CPW) feed and capacitively feeds metal mesh segment #1. Active metal mesh segment #3 is electrically connected to active segment #1 and is located at same side corner of segment #2. The two sides of segment #3 are in parallel with segment #1, such that the current at the two open edges of segment #3 are also orthogonal to each other. Adjusting the dimension of these two edges generates a 90-degree phase difference between the antenna's two orthogonal E-field components when the RHCP antenna is resonating at the desired frequency.

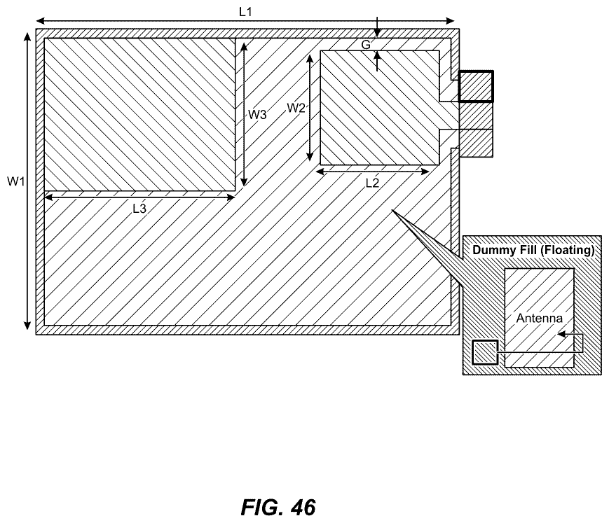

FIG. 46 illustrates a transparent, uniplanar, right hand circularly polarized (RHCP) antenna constructed from transparent metal mesh. This antenna includes a square lattice structure metal mesh that was fabricated using copper wires, with a mesh pitch of, for example, 100 um, a mesh width of 2 um, and thickness of 1 um. This configuration may yield approximately 96% optical transmittance and a sheet resistivity of 2 Ω/sq for the metal mesh used in the antenna. As depicted in FIG. 46, the metal mesh may be divided into active (blue) and dummy/floating (gray) segments using precise incision in which select portions of mesh are removed to separate the active portions from the dummy portions.

Additionally, a metalized border with a width of 1 mm, for example, may be applied to the perimeter of the transparent metal mesh. The metalized border's dimensions may be defined by L1 and W1. The metalized border may be hidden within the glass frame and may not be visible to the end users. The embodiments herein may reduce the sheet resistance on the edges, where the current concentration is highest, so as to enhance the radiating efficiency of the antenna. The RHCP antenna may be considered as a wide slot antenna that is excited by the active metal mesh segment L2×W2, which may be connected to a coplanar waveguide (CPW) feed. By adjusting the dimensions of the active metal mesh segment L3×W3 connected to the metalized border at the corner, a 90° phase difference may be achieved between two orthogonal electrical field (e-field) components without the need for external phase-shift networks or phase delay transmission lines, as may otherwise be required in dual-feed or single-feed circularly polarized patch or slot antennas.

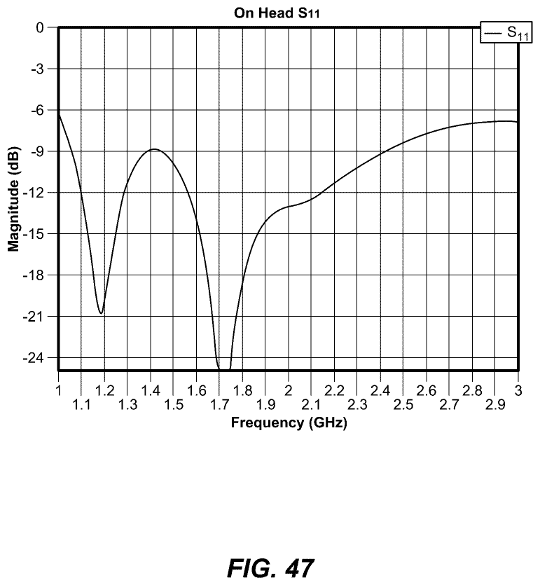

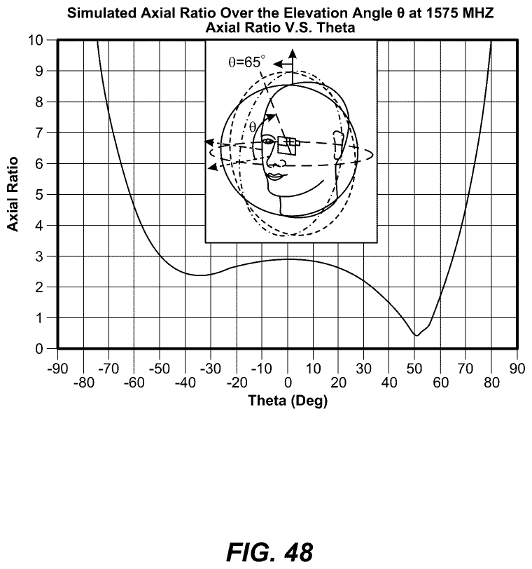

The simulated return loss and axial ration for this transparent right hand circularly polarized antenna are illustrated in FIGS. 47 & 48. In these charts, the RHCP antenna may have specified dimensions of L1=50 mm, W1=36 mm, L2=14 mm, W2=13.5 mm, L3=22.5 mm, W3=18 mm, g=1 mm, and sheet resistivity of 2 Ω/sq for active metal mesh segments, while 0.028 Ω/sq may be assigned to all metalized segments. The transparent metal mesh may be placed on top of a 5-mm thick transparent acrylic substrate having a dielectric constant of Dk=2.7 and loss tangent of Df=0.002. A broad S11≤−10 dB impedance band may be produced to fully encompass the circularly polarized (CP) band.

Furthermore, it should be noted that the CP band may be adjusted by altering the dimensions of active metal mesh segments L3 and W3, while keeping all other antenna parameters constant. Additionally, it should be noted that variations in the dimensions of active metal mesh segment L2, W2 and gap g will not shift the resonance frequency in GPS signals but will affect the antenna's impedance matching. Ideally, GPS antennas should have good RHCP radiation over the entire upper hemisphere to efficiently receive incoming GPS signals. However, due to head blockage, most radiation is reflected in the forward direction. FIG. 4 illustrates that good RHCP radiation (AR<3) can be maintained for the RHCP antenna at 65° elevation angle towards the upper hemisphere, even in the presence of a user's head.

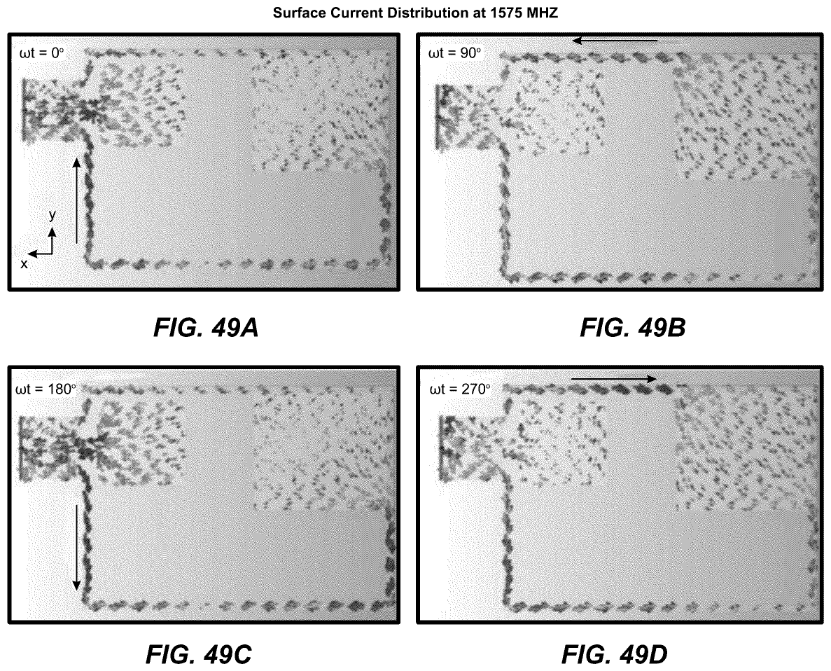

In order to examine the slot region of the RHCP antenna in more detail, FIGS. 49A-49D present the simulated surface current at a frequency of 1575 MHz. By disregarding the weaker currents, the predominant current components at four time instants: ωt=0°, 90°, 180°, 270° are found to be Jy+, Jx+, Jy−, Jx−. This indicates that the electrical current in the slots rotates counterclockwise as the time phase increases, demonstrating that the fields radiating in the +z direction are right hand circular polarized. In these embodiments, a uniplanar, RHCP antenna was designed using transparent metal mesh for GPS communication. The proposed antenna, composed of active mesh segments, dummy mesh segments, and a metalized border, collectively form a transparent antenna exhibits a wide impedance bandwidth, enhanced radiation efficiency, and an optimal AR bandwidth across the targeted frequency band, and as such, may be used in frequency bands other than GPS. Still further, these embodiments may enable GPS technology in augmented reality glasses, in smartphones, in smartwatches, or other mobile electronic devices.

In one specific embodiment, a system is provided. The system may include a substrate, a transparent conductive material applied to the substrate in a specified pattern that forms an antenna, and an electrically conductive border at least partially surrounding the substrate. In some cases, the transparent conductive material may be applied in at least two separate sections of the substrate. In such cases, the two separate sections of the substrate are separated by portions of non-conductive transparent material. This antenna may be a slot antenna or other type of antenna, which may be applied to the outer surface of a pair of AR glasses.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising one of:
a waveguide coupling system, including:
a waveguide comprising:
an in-coupling region; and
an out-coupling region comprising a plurality of multiplexed volumetric Bragg gratings;
wherein guiding angles and out-coupled angles of the waveguide are selected to provide a wide field of view with substantially no cross-talk;
a method for human-computer interaction, including:
measuring from different angles, by at least one processor and using an imaging technique, skin hair coverage in a skin surface region of a user;
determining, by the at least one processor and based on the measurements, specifications of biopotential electrodes including microstructures on a surface thereof configured to contact the skin surface region of the user and locations of the biopotential electrodes on a wearable device; and
performing human-computer interaction, by at least one processor, based on biopotential measurements provided by the biopotential electrodes that include microstructures on the surface thereof that are configured to contact the skin surface region of the user;
a method for identifying and mitigating escalating behavior in public messaging forums, including:
seeding low confidence keywords and phrases in a text bank;
comparing in-coming public messages against the text bank to identify potentially harmful public messages;
determining a virality score for each of the identified potentially harmful public messages; and
submitting potentially harmful public messages with virality scores above a threshold score for human review;
a method for tensor-based cluster matching for optics system color matching, including:
receiving, by at least one processor, imaging results from at least one imaging device;
estimating, by the at least one processor and based on the imaging results, a color correction matrix at least in part by integrating additional variables into a 5-dimension tensor-based procedure with a geometric, exposure time look-up-table and a conjugate of a camera vignette factor;
storing, by the at least one processor, the color correction matrix in a memory accessible to the at least one processor; and
employing, by the at least one processor, the color correction matrix to modify the imaging results; or
a system for transparent circular polarized antenna on lens, comprising:
a substrate;
a transparent conductive material applied to the substrate in a specified pattern that forms an antenna; and
an electrically conductive border at least partially surrounding the substrate.

2. The waveguide coupling system of claim 1, wherein the waveguide material has a refractive index of less than approximately 2.

3. The waveguide coupling system of claim 2, wherein the waveguide material has a refractive index of approximately 1.5.

4. The waveguide coupling system of claim 1, further comprising a plurality of waveguides.

5. The waveguide coupling system of claim 4, wherein each of the plurality of waveguides corresponds to a separate light color.

6. The waveguide coupling system of claim 5, wherein volumetric Bragg gratings in each of the plurality of waveguides have different sets of pitches and slant angles.

7. The waveguide coupling system of claim 1, wherein the field of view is greater than approximately 30°.

8. The waveguide coupling system of claim 1, wherein the field of view is approximately 120°.

9. The waveguide coupling system of claim 1, wherein the light source comprises at least one laser.

10. The waveguide coupling system of claim 9, wherein the at least one laser comprises a tunable wavelength laser.

11. The waveguide coupling system of claim 9, wherein the at least one laser comprises a plurality of lasers that each emit a separate color of light.

12. The waveguide coupling system of claim 1, further comprising an intermediate grating region disposed between the in-coupling region and the out-coupling region.

13. The waveguide coupling system of claim 12, wherein the intermediate grating region comprises a mirror array arranged along a light path through the waveguide.

14. The waveguide coupling system of claim 13, wherein the mirror array reflects light towards the out-coupling region.

15. A display system, comprising:
a light source; and
a waveguide coupler configured to couple light from the light source, the waveguide coupler comprising:
an in-coupling region; and
an out-coupling region comprising a plurality of multiplexed volumetric Bragg gratings;
wherein guiding angles and out-coupled angles of the waveguide coupler are selected to provide a wide field of view with substantially no cross-talk.

16. The display system of claim 15, wherein the waveguide material has a refractive index of less than approximately 2.

17. The display system of claim 15, further comprising a plurality of waveguides.

18. The display system of claim 15, wherein the field of view is greater than approximately 30°.

19. The display system of claim 15, wherein the light source comprises at least one laser.

20. The display system of claim 15, further comprising an intermediate grating region disposed between the in-coupling region and the out-coupling region.
